(19) United States
(12) Patent Application Publication
(10) Pub. No.: US 2026/0217952 A1
(43) Pub. Date: Jul. 30, 2026

(54) SYSTEMS AND METHODS FOR IMPROVED COMPOSITE MATERIALS USING COAL CHAR

(71) Applicant: UNIVERSITY OF WYOMING, Laramie, WY (US)

(72) Inventors: Xinyan WANG, Laramie, WY (US); Ali Reza JANIJAM, Laramie, WY (US); Hannah THOMAS, Laramie, WY (US); Stefan HOLBERG, Laramie, WY (US); Patrick JOHNSON, Laramie, WY (US)

(73) Assignee: University of Wyoming, Laramie, WY (US)

(21) Appl. No.: 19/145,005

(22) PCT Filed: Jan. 18, 2024
(86) PCT No.: PCT/US24/11942

§ 371 Date: Jul. 1, 2025

Related U.S. Application Data
(60) Provisional application No. 63/480,567, filed on Jan. 19, 2023.

(51) Int. Cl. C08K 11/00; C08J 3/20; C08J 3/21; C08L 61/12; C08L 61/34; C08L 97/02

(52) U.S. Cl. CPC C08K 11/005; C08J 3/203; C08J 3/212; C08L 61/12; C08L 61/34; C08L 97/02; C08J 2361/12; C08J 2361/34; C08J 2397/02

(57) ABSTRACT

Methods for producing a polymer composite material via a coal-derived feedstock. In one example, the method includes: pyrolyzing a coal-derived feedstock to produce coal char particles; mixing the coal char particles with a polymer precursor to produce a composite precursor; curing the composite precursor to produce a polymer composite material, wherein the curing includes: heating the composite precursor; and compressing the composite precursor. The composite precursor may be a powder mixture. The curing temperature may be between 8° and 250° C. The method may include dispersing the polymer precursor with a solvent.

### CROSS-REFERENCE TO RELATED APPLICATIONS

This application claims the benefit of priority to U.S. Provisional Patent Application No. 63/480,567, filed Jan. 19, 2023, which is hereby incorporated by reference in its entirety.

### BACKGROUND OF INVENTION

Coal is an abundantly available and economic source for electricity generation for the past decades. However, the consumption of coal is continuously declining due to the development of renewable energy resources and new environment regulations. With huge accessible reservoirs and low cost, more opportunities are being established for entrepreneurs and researchers to develop non-energy coal derived products. Coal char, which is the solid residue formed from the pyrolysis process of coal, usually accounting for roughly 50 wt % of coal, attracts significant research interest. To utilize the coal char more efficiently and cleanly, most of the research is focused on the kinetics combustion of coal char or its further gasification. Nevertheless, the current trend in coal char research won't completely eradicate the environmental effects.

Phenolic resin is synthesized via condensation of phenol-formaldehyde. The ratio of phenol to formaldehyde as well as the type of catalyst are two variables that determine whether a given resin may be categorized as resol or novolac. Novolac resins are normally used for applications as molding compounds and laminates due to its more stable dimensions. They are also of interest for uses in ablative thermal protections benefiting from its low cost, high mechanical properties, high char yield and fire retardance. The phenolic novolac resins are commonly used with low-cost fillers including clay, talc, wood flour, etc. Excluding wood flour/saw dust, all common mineral fillers are expected to be more expensive than coal char, especially on a cost per volume base due to their higher density.

It can be seen from the above that improved composite materials and new uses for coal are needed.

### SUMMARY OF THE INVENTION

Provided herein are systems and methods for producing composite materials from coal char dispersed in a polymeric matrix. In aspects, the composite materials comprise a phenolic resin (a thermosetting polymer resin) as the polymer matrix, with coal char as the particulate filler. In aspects, the material has exceptional compressive strength. In aspects, for example, the material has a compressive strength a magnitude higher than brick or concrete.

The high compressive strength combined with the use of coal char as an economic filler can reduce the price compared to other fillers. Furthermore, thermal stability (low weight loss at high temperatures, such as in case of a fire, see TGA results) of the disclosed composites is better than conventional phenolic resin composites using other organic fillers such as saw dust or un-pyrolyzed coal.

Thus, these materials may, in some aspects, find use as load-bearing building materials. When compared to conventional building materials (brick, concrete) the disclosed materials provide more strength per cost, and/or produce less CO2 in their production.

In one aspect, a method for producing a polymer composite material via a coal-derived feedstock comprises: pyrolyzing a coal-derived feedstock to produce coal char particles; mixing the coal char particles with a polymer precursor to produce a composite precursor; curing the composite precursor to produce a polymer composite material, wherein the curing comprises polymerizing the polymer precursor of the composite precursor to form a three-dimensionally chemically cross-linked network. In one aspect, the curing comprises: heating the composite precursor; and compressing the composite precursor.

In one aspect, the composite precursor is a powder. The skilled person will know the common methods of blending the polymer precursor, such as using heated calender rolls or heated extruders. In one aspect, the composite precursor is prepared by mixing of dry powders without heating, which is simpler than the common processes. In one aspect, the curing temperature is between 8° and 250° C. The skilled person will know to adapt the suitable curing temperature according to the respective polymer precursor. In this aspect, the curing temperature should be low enough to avoid pyrolysis of the polymer precursor. In one aspect, heating and pressing are applied simultaneously. In one aspect, the method comprises contacting the polymer precursor with a solvent. In one aspect, the mixing step comprises mixing the coal char particles, the polymer precursor and the solvent. In one aspect, the composite precursor is a slurry during the process of mixing. In one aspect method comprises, prior to the curing step, removing at least some of the solvent from the composite precursor slurry. In one aspect, the removing step comprises heating the composite precursor slurry, placing the composite precursor slurry under vacuum, and combinations thereof. In one aspect, the solvent is an organic solvent. In one aspect, the solvent is an aprotic solvent. In one aspect, the solvent is a polar solvent. In one aspect, the solvent is a polar, aprotic solvent that is not a ketone or aldehyde. In this aspect, the solvent does not dissolve or reacts with any alkaline mineral matter that may be present in the coal char. In one aspect, the solvent is tetrahydrofuran.

In one aspect, the coal char particles have a cross-sectional dimension less than or equal to 200 μm. In one aspect, the coal char particles have a cross-sectional dimension less than or equal to 150 μm. In one aspect, the concentration of coal char particles in the polymer composite material is 40-90 wt. %. In one aspect, the concentration of coal char particles in the polymer composite material is 50-80 wt. %. A high char concentration is expected to result a more economic composite.

In one aspect, the pyrolyzing step comprises heating in the absence of oxygen to a temperature of 500-2000° C. In one aspect, the pyrolyzing step comprises heating in the absence of oxygen to a temperature of 600-1500° C. In one aspect, the pyrolyzing step comprises heating in the absence of oxygen to a temperature of 800-1100° C. In one aspect, the pyrolyzing step comprises heating in the absence of oxygen to a temperature of 850-1000° C.

In one aspect, the coal-derived feedstock is produced via subbituminous and/or lignite coal. In one aspect, the pyrolyzing step has a duration of 3 hours or less. In one aspect, the pyrolyzing step has a duration of 20 minutes or less. In one aspect, the pyrolyzing step has a duration of 30 seconds or less. As common form of coal char is metallurgical coke, requiring pyrolyzing metallurgical coal for over 10 h to achieve desired mechanical strength. Applying more economic, non-metallurgical coal such as subbituminous coal, and using shorter processing times than a coke oven result both in more economic char.

While the pyrolysis step generally occurs in the absence of oxygen, In one aspect of the pyrolysis, the pyrolysis vessel may initially contain oxygen from the air, however this oxygen is soon consumed and no further air is added.

In one aspect the composite precursor comprises non-coal char particles. In one aspect, the non-coal char particles include wood particles. In one aspect, the non-coal char particles may comprise un-pyrolyzed coal particles. Thus, in aspects, the composite material may comprise a combination of pyrolyzed coal char particles and un-pyrolyzed coal particles. In one aspect, the composite precursor comprises coal char particles and non-coal char particles, wherein the non-coal char particles are not molten or dissolved during the curing process, and wherein the concentration of coal char particles in the polymer composite material is at least 25 wt. % and the concentration of coal char particles and the non-coal char particles together in the polymer composite is at least 50 wt. %.

In one aspect, the polymer precursor comprises a thermosetting resin. In one aspect, the polymer precursor comprises a phenolic resin precursor. In one aspect, the polymer precursor comprises a phenolic novolac resin precursor. In one aspect, the polymer precursor comprises a phenolic resole resin precursor. Thermoset resins react during curing and have thus different capabilities to interact with any added fillers than thermoplastics have. As the curing reactions are different, the performance of a filler in a composite may, to some degree, depend on the thermoset's chemistry.

In one aspect, the polymer precursor comprises an amino resin precursor. In one aspect, the polymer precursor comprises a melamine resin precursor. In one aspect, the polymer precursor comprises a urea resin precursor.

In one aspect, the polymer precursor comprises at least 60 wt. % of any of the resins from the group of phenol-formaldehyde resin, melamine-formaldehyde resin or urea-formaldehyde resin. In one aspect, the polymer precursor comprises at least 50 wt. % phenol-formaldehyde resin. Phenolic, melamine and urea resins are economic, provide high strength, reasonable temperature and fire resistance, and share a similar curing mechanism. Especially phenolic resins provide higher strength and fire resistance than most other thermosets. It is known to the skilled person, that phenolic and amino resins can be used pure or in combination with other resins such as co-curing of phenolic resins with melamine resin. Furthermore, it is known that there are modified resins which comprise substituted phenols, alternative aldehydes or ketones than formaldehyde or further modifiers. The intervals provided above shall ensure that the main characteristic properties of the mentioned resins are present, and distinguish from uses not considered in this embodiment, where these resins are simply used as additive or curing agent.

In one aspect, building materials produced via the disclosed method. In one aspect, the building material may be configured for load-bearing structures. The combination of high strength, fire resistance and low cost allows the hitherto not common application of these composites in in load bearing structures. In one aspect, the building material has compressive strength of at least 100 MPa. In one aspect, the building material has tensile strength of at least 5 MPa.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an aspect of the invention can nonetheless be operative and useful.

### BRIEF DESCRIPTION OF THE DRAWINGS

FIGS. 1A-1B: Compressive and tensile properties of phenolic composites with different concentrations of coal char: (FIG. 1A) compressive strength, (FIG. 1B) tensile strength.

FIGS. 2A-2B: Compressive strength (FIG. 2A) and compressive modulus (FIG. 2B) of phenolic composites with 67 wt % of coal char dispersed by different solvents.

FIGS. 3A-3B: Compressive and tensile properties of phenolic composites with different concentrations of coal char after THF treatment: (FIG. 3A) compressive strength, (FIG. 3B) tensile strength.

FIGS. 4A-4H: SEM micrographs (130×200 μm) of composite samples taken on the fracture surface after tensile test: (FIG. 4A) CC00; (FIG. 4B) SD50; (FIG. 4C) Ref; (FIG. 4D) CC50; (FIG. 4E) CC67; (FIG. 4F) THF50; (FIG. 4G) THF67; (FIG. 4H) THF80.

FIG. 5A: TGA and (FIG. 5B) DTG curves of selected polymer composites.

FIGS. 6A-6C: DSC thermograms of (FIG. 6A) the phenolic resin, (FIG. 6B) PR/CC, and (FIG. 6C) PR/CC-s at different heating rates (3-10° C./min).

FIG. 7: Relationship between the curing temperatures and heating rate of PR-CC-s composite.

FIG. 8: Degree of conversion as a function of temperature for the samples at heating rate of 3° C./min.

FIG. 9: Kissinger plot for the PR/CC-s composite.

FIG. 10: Starink plots at different degrees of conversion for the PR/CC-s composite.

FIG. 11: Activation energy as a function of degree of conversion for the samples.

FIG. 12: da/dt vs. a curves of the samples at heating rate of 3° C./min.

FIG. 13: ln(Af(α)) vs ln(1−α) plots for the samples at heating rate of 3° C./min.

FIGS. 14A-14C: Degree of conversion as a function of temperature for (FIG. 14A) the phenolic resin, (FIG. 14B) PR/CC, and (FIG. 14C) PR/CC-s at different heating rates (3-10° C./min).

FIG. 15: da/dt vs. a plots at various heating rates for the PR-CC composite.

FIGS. 16A-16B: Scanning Electron Microscope images of the microstructure of sawdust (FIG. 16A) and coal char (FIG. 16B).

FIG. 17A: Compressive strength as a function of coal char particulate size for composite samples comprising 50 wt. % coal char.

FIG. 17B: Compressive modulus as a function of coal char particulate size for composite samples comprising 50 wt. % coal char.

### STATEMENTS REGARDING CHEMICAL COMPOUNDS AND NOMENCLATURE

In general, the terms and phrases used herein have their art-recognized meaning, which can be found by reference to standard texts, journal references and contexts known to those skilled in the art. The following definitions are provided to clarify their specific use in the context of the invention.

The term “pyrolyzing” refers to heating in the absence of oxygen. While the pyrolysis step generally occurs in the absence of oxygen, in one aspect of the pyrolysis, the pyrolysis vessel may initially contain oxygen from the air, however this oxygen is soon consumed and no further air is added. In one aspect, the pyrolysis occurs at a temperature of at least 500° C. In one aspect, the pyrolysis occurs at a temperature of at least 600° C. In one aspect, the pyrolysis occurs at a temperature of at least 700° C. In aspects, the coal char is heated to 850-1000° C.

As used herein the term “coal char”, also called pyrolysis char, refers to coal that has been heated in the absence of oxygen. As noted above, the pyrolysis vessel may initially contain air, the oxygen therein being consumed at the beginning of the pyrolysis, but no additional oxygen is added. Coke, such as metallurgical coke used for steel making, is one example of coal char.

In an aspect, a composition or compound of the invention, such as an alloy or precursor to an alloy, is isolated or substantially purified. In an aspect, an isolated or purified compound is at least partially isolated or substantially purified as would be understood in the art. In an aspect, a substantially purified composition, compound or formulation of the invention has a chemical purity of 95%, optionally for some applications 99%, optionally for some applications 99.9%, optionally for some applications 99.99%, and optionally for some applications 99.999% pure.

### DETAILED DESCRIPTION OF THE INVENTION

In the following description, numerous specific details of the devices, device components and methods of the present invention are set forth in order to provide a thorough explanation of the precise nature of the invention. It will be apparent, however, to those of skill in the art that the invention can be practiced without these specific details.

The invention can be further understood by the following non-limiting examples.

### Example 1: Coal Char as an Economic Filler for Novolac Phenolic Polymer Composites

### Materials and Methods

The coal char was provided by Atlas Carbon LLC. The coal char was pyrolyzed at 850° C. Wood flour fine sawdust was purchased from Shannons Sawmill via Amazon. Black phenolic powder was purchased from Sturbridge Metallurgical Services, Inc. Pure phenolic resin, BK 5520 PARAC Phenolic Resin was provided by Bakelite Chemicals LLC. Tetrahydrofuran (THF) was purchased from Sigma-Aldrich. Methanol was purchased from VWR. Ethanol was purchased from Acros Organics. Acetone was purchased from Fisher Chemical.

### Composite Preparation

The phenolic polymer composites are mixed by two methods, dry powder mixing or using solvent. For powder mixing, different amounts of coal char or sawdust were mixed with BK 5520 PARAC Phenolic Resin powder for 2 mins by a vortex mixer. For solvent method, the phenolic resin was first dissolved in the solvent. Different amounts of coal char were well dispersed in the solution by a high-speed disperser at 3000 rpm for 10 mins. The solvent was removed by drying, first in a ventilated oven for about 2 h at 70° C., then in a vacuum oven at 0.5 mbar for 12 h at 70° C. The dried material was then smashed by a lab mill. The mixing material was pressed under hot press at 160° C. in compression and tensile molds, for 25 mins at 26.5 MPa and 40 mins at 7.4 MPa, respectively. An 8 mm diameter cylinder mold was used for compression samples and a 120*90 mm rectangular mold was used for preparing the tensile sheets. The sheets were cut into type V dog bone shapes by waterjet as tensile specimens.

### Composite Analysis

The compressive and tensile behavior of the composites were studied using a universal testing machine (ZwickRoell Z100). Compressive strength and modulus of elasticity were determined according to ASTM-D695-15 on 5 cylindrical specimens for each material. Tensile strength were determined according to ASTM D638-14 on 5 type V dog bone specimens for each material.

Thermogravimetric Analysis (TGA) was performed with a TA TGA Q50. Around 15 mg sample was loaded onto a platinum pan, held isothermally at room temperature for 5 mins, then heated to 950° C. at a rate of 10° C./min in argon.

The morphologies of the composites were studied by scanning electron microscopy (FEG-250 SEM). Images were taken on the fracture surfaces after test. All the samples were coated by carbon for more electrical conductivity.

### Mechanical Properties of the Powder Mixing Composites

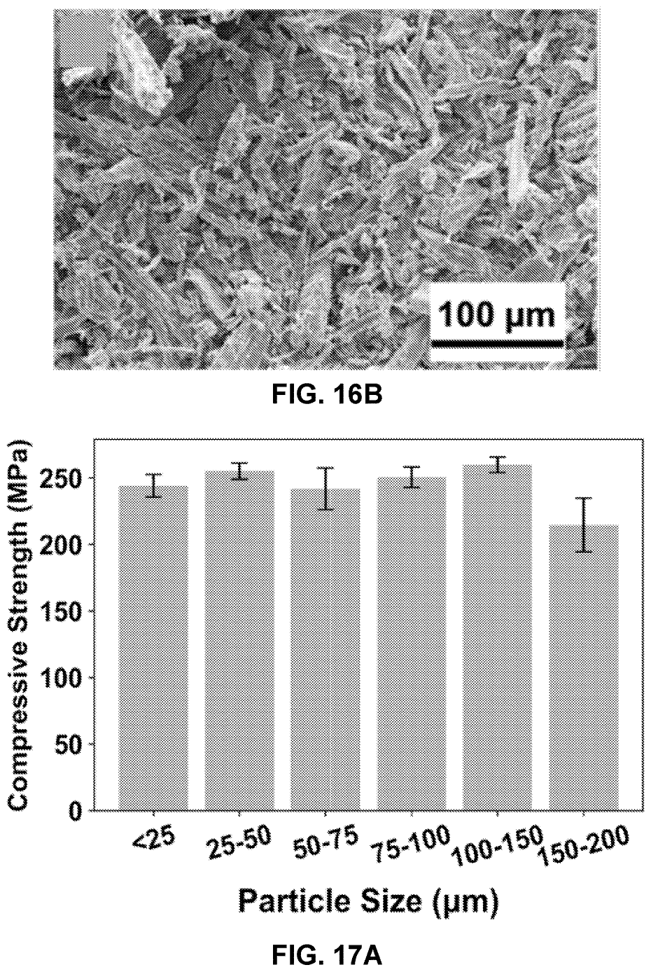

The mechanical properties of phenolic composite with 50% of coal char was compared with the composite with 50% of sawdust as a filler using the same pure phenolic resin (BK 5520) and also the composite from commercial phenolic novolac resin with unknown fillers. As can be seen in Table 1, 50% of coal char composite displayed the highest maximum compressive strength up to 246 MPa, which achieved 25% improvement of compressive strength compared to reference composite and 50% of sawdust composite, while the ultimate tensile strength was much lower. Sawdust is expected to show higher tensile strength due to its fiber structure (see microstructure of sawdust and coal char in FIGS. 16A and 16B). The elastic modulus of 50% of coal char composite was considerably higher than reference composite and 50% of sawdust composite. The results showed that coal char has a good opportunity to be involved in some applications which need high compressive strength and elastic modulus with reasonable tensile strength like load-bearing building materials.^{29,30}

TABLE 1
Compressive and tensile properties of reference,
50% coal char and 50% sawdust composites.

| | Compressive | Tensile | Young's |
|---|---|---|---|
| | Strength | Strength | Modules |
| Composite Type | (σ, MPa) | (σ, MPa) | (E, GPa) |
| Reference | 197 ± 4 | 53 ± 2 | 3.67 ± 0.13 |
| 50% Coal Char | 246 ± 9 | 31 ± 2 | 5.01 ± 0.36 |
| 50% Sawdust | 198 ± 9 | 63 ± 3 | 3.17 ± 0.29 |

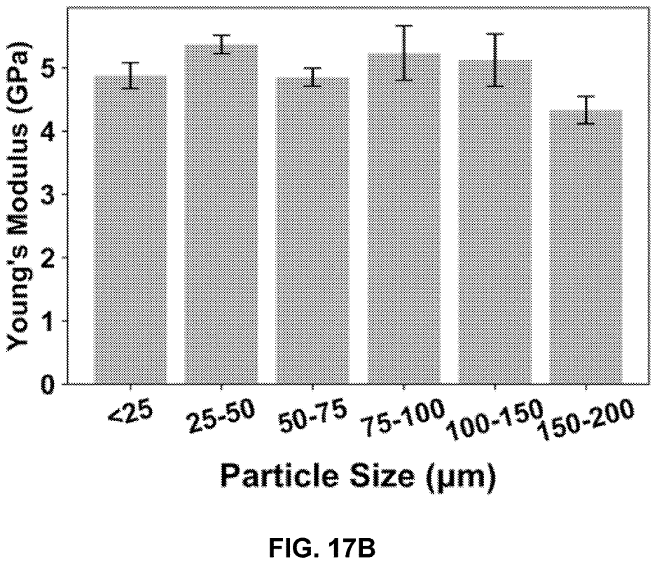

The influence of particle size on the compressive strength and elastic modulus of the coal char composite was investigated for composite samples comprising 50 wt. % coal char over a range of particulate sizes from <25 to 200 μm. As shown in FIGS. 17A-B, when particle size was less than 150 μm, the influence was minimal on the compressive strength and modulus. Larger particles decreased the compressive strength and modulus of the composites due to the insufficient dispersion and interaction with matrix^{31,32}. In the following experiment, the particle size of coal char was used consistently as smaller than 80 μm.

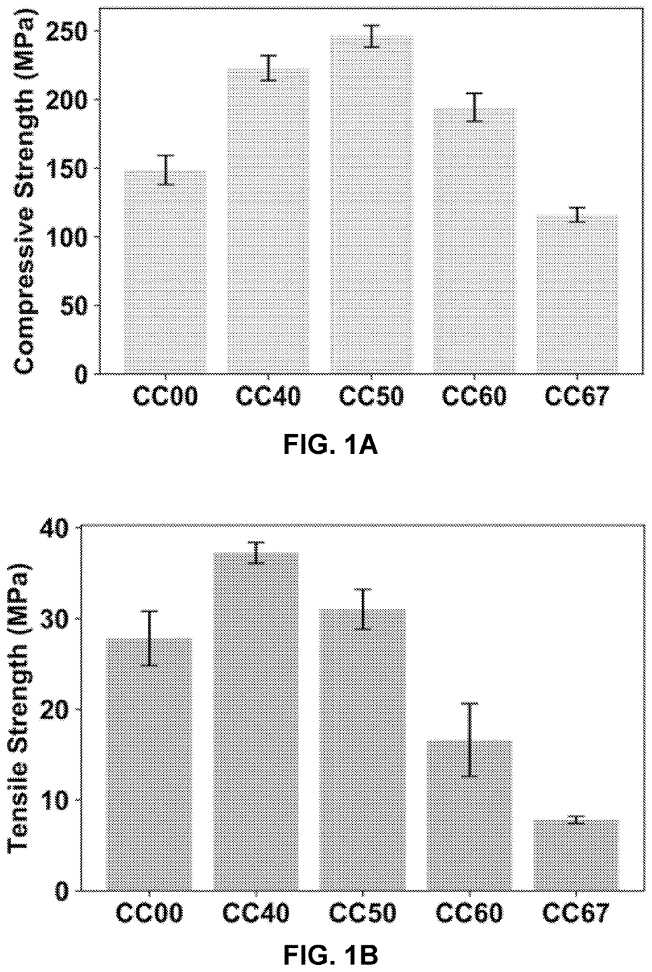

Considering different concentrations, composites with 0%, 40%, 50%, 60%, 67% coal char are named as CC00, CC40, CC50, CC60, and CC67, respectively. FIGS. 1A-1B show the effect of coal char concentrations on compressive and tensile properties of phenolic composites. FIG. 1A illustrates that maximum compressive strength was increasing with the increase in the coal char content up to 50 wt. % with 65% improvement compared to the polymer made from pure phenolic resin and started to decrease beyond 60 wt. %. There was a significant drop of strength at 67 wt. %, of which the compressive strength was even lower than pure phenolic resin, due to the poor interfacial adhesive bonding of the particles with the surrounding polymer matrix. 33 As can be seen in FIG. 1B, the compressive modulus also displayed a similar trend. Considering ultimate tensile strength, 40 wt. % coal char achieved the maximum tensile strength at 37 MPa, which obtained 32% improvement based on the pure resin polymer but still not comparable with commercial polymer composite and sawdust composite. Beyond 60 wt. % of loading, the incorporation of coal char negatively impacted on the ultimate tensile strength of composites. The stiffness of composites also decreased when the coal char content was greater than 60 wt % as shown in Table 2.

TABLE 2
Compressive modulus of phenolic
composites with different concentrations of coal char.

| Composite | CC00 | CC40 | CC50 | CC60 | CC67 |
|---|---|---|---|---|---|
| Young's | 3.57 ± 0.18 | 4.77 ± 0.20 | 5.01 ± 0.36 | 4.77 ± 0.26 | 3.56 ± 0.20 |
| Modulus | | | | | |
| (E, Gpa) | | | | | |

Influence of solvent dispersion on compressive properties of composites

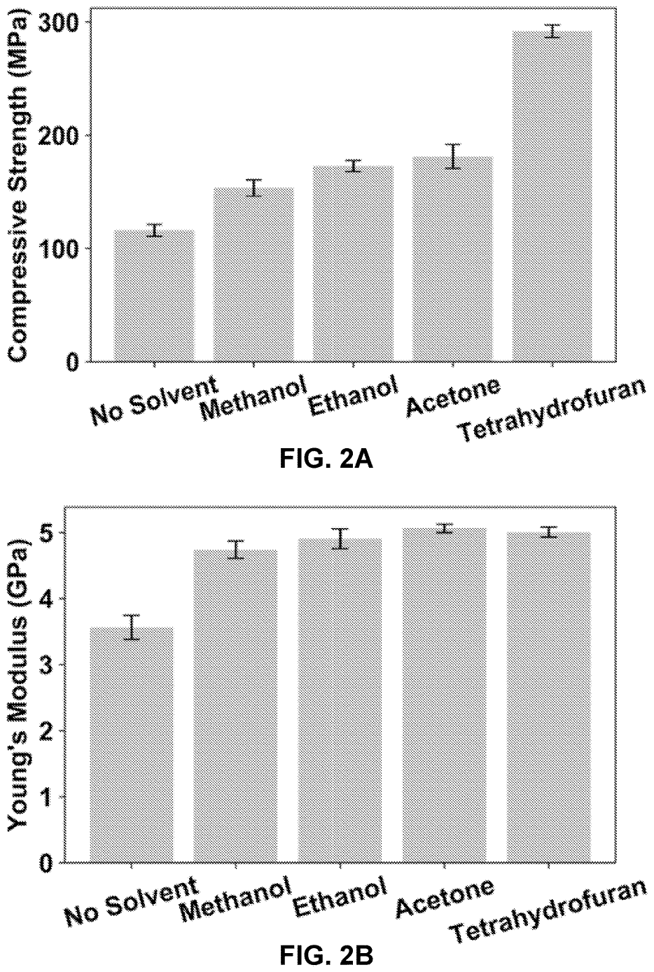

Dispersion plays a significant role in mechanical properties of polymer composites.³⁴ To add as much economic coal char as possible and enhance the mechanical properties, four different solvents (methanol, ethanol, acetone, tetrahydrofuran) have been utilized to disperse coal char in phenolic resin solutions. All samples contained 67% coal char. From FIGS. 2A-2B, it was observed that the composites dispersed by solvents all obtained a significant improvement on the modulus, from 3.56 GPa to around 5 GPa, while the samples used tetrahydrofuran as a disperse solvent achieved the highest compressive strength at 292 MPa, compared to methanol, ethanol, and acetone treatment. Though other solvents also revealed an increased effect on compressive strength of composites, tetrahydrofuran assisted the composites with an impressively 157% improvement on the compressive strength in comparison with powder mixing method. It could be attributed to the better resin solubility or less solubility of any mineral matter of the coal char may comprise. 35 More phenolic molecules can diffuse into the micropores of coal char, resulting in better mix and connection between them. Thus, it was convinced that using tetrahydrofuran as a dispersion solvent was an effective method and process to improve the mechanical properties of phenolic polymer composites.

The composites produced using acetone as the dispersion solvent generally had lower strength than those produced work as well as THF. Without wishing to be bound by theory, it is postulated that of the differences is that that ketones or aldehydes might react with strong bases, which may be present in the char.

Mechanical Properties of the Coal Char Composites with THE Dispersion Method

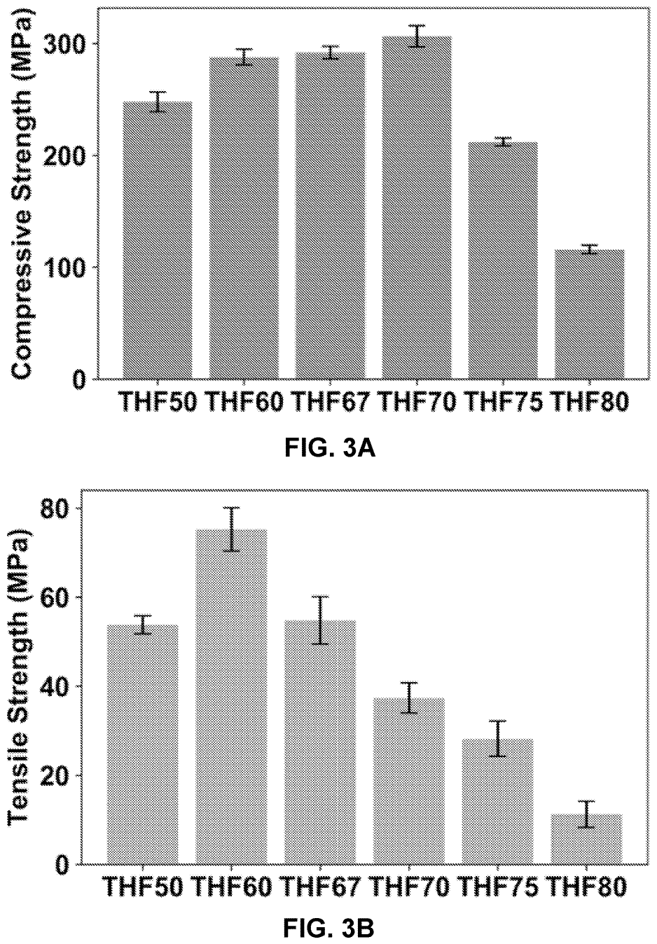

FIGS. 3A-3B and Table 3 showed the mechanical properties of phenolic composites with different concentrations of coal char with tetrahydrofuran dispersion method. Composites with 50%, 60%, 67%, 70%, 75%, 80% coal char are named as THF50, THF60, THF67, THF70, THF75 and THF80, respectively. As shown in FIG. 3A, the compressive strength increased with the increase in coal char concentration until 70% and then started to decline with further increase. The maximum compressive strength reached 307 MP. Tensile strength achieved a maximum value of 75 MPa at 60 wt % of coal char and diminished thereafter. It is worthy to notice that THF50, THF60 and THF67 all had improved compressive strength and comparable tensile strength with commercial polymer composite, where impressively, THF60 even had a higher tensile strength than phenolic composite with 50 wt % of sawdust. Young's modulus of composites resembles like the compressive strength trend with a maximum value of 5.37 GPa with 70 wt % of coal char. Interestingly, compared with the values in Table 1, the elastic modulus of THF50 (4.37 GPa) was smaller than powder mixing sample CC50 (5.01 GPa) but retained the same compressive strength, while the modulus of THF60 (4.96 GPa) and THF67 (5.00 GPa) were greater than CC60 (4.77 GPa) and CC67 (3.56 GPa). That means, THE treatment had the trend to reduce the stiffness of the coal char but at the same time, better dispersion helped the composites improve the mechanical strength and reduce the generation of cavities and defects. Though the mechanical results of THF80 was not ideal, it could be still interesting to some specific applications like load-bearing building materials, which prefer economic material with reasonable mechanical properties.

TABLE 3
Compressive modulus of phenolic composites with different
concentrations of coal char with THF dispersion method.

| Composite | THF50 | THF60 | THF67 | THF70 | THF75 | THF80 |
|---|---|---|---|---|---|---|
| Young's | 4.37 ± | 4.96 ± | 5.00 ± | 5.37 ± | 4.91 ± | 4.25 ± |
| Modulus | 0.29 | 0.10 | 0.08 | 0.21 | 0.11 | 0.09 |
| (E, Gpa) | | | | | | |

### Morphology of the Fracture Surface of the Composites

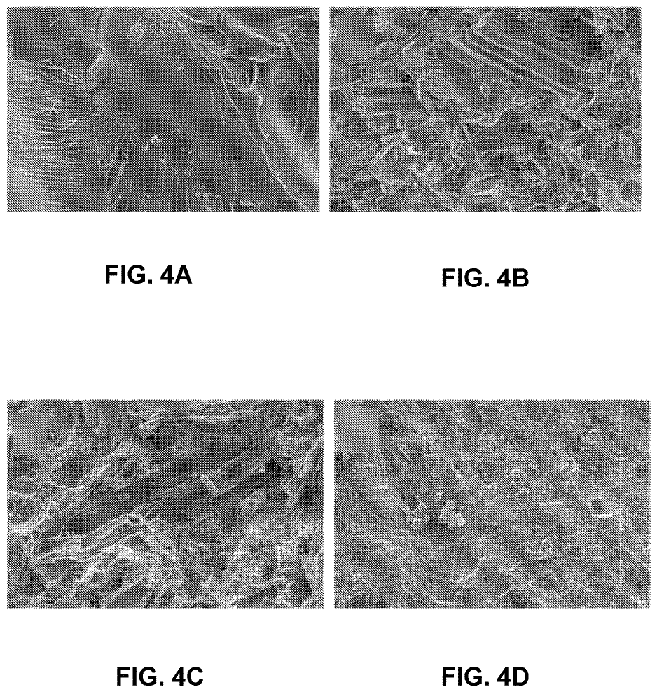

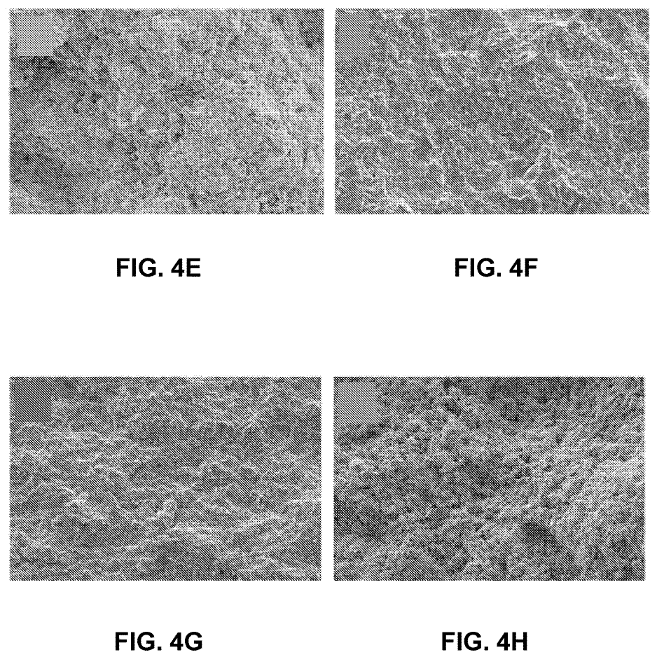

FIGS. 4A-4H showed the scanning electron microscopy (SEM) images of the composites from commercial resin, pure phenolic polymer, and the derived composites with fillers. It was observed in FIG. 4A that the fracture surface of pure phenolic polymer was smooth with a certain degree of brittle fracture after drawing. In contract, the composites with fillers displayed rough surfaces without visible microcracks, indicating that the stiff fillers interlocking with polymer molecules shared the loading strength and avoided the occurrence of the cracks.³⁶ Compared to the morphology of the composite containing sawdust (FIG. 4B) and the composites containing coal char (FIG. 4D), it was clear that the commercial composites combing both fiber and particles as fillers. It was a hint that hybrid fillers can be investigated in the future study. As seen in FIGS. 4D and 4F, the roughness of CC50 and THF 50 was similar, and the dispersion were sufficient, but the composites with THF method had less cavities, which further confirmed the swelling effect of THF on coal char. The powder mixing sample (FIG. 4E) showed large aggregation when the coal char concentration increased to 67% while the THF method sample (FIG. 4G) had less effect on the morphology, exhibiting better dispersibility. THF 80 (FIG. 4H) displayed similar aggregation with CC67 (FIG. 4E), which gave rise to stress concentration and led to poor mechanical properties.³⁷ Overall, the morphology of the composites was consistent with the mechanical results. Filler aggregation emerged when increasing the filler amount and reduce the mechanical performance of the composites and the THF method could retard the influence and retained the properties.

### Thermal Properties of the Prepared Composites

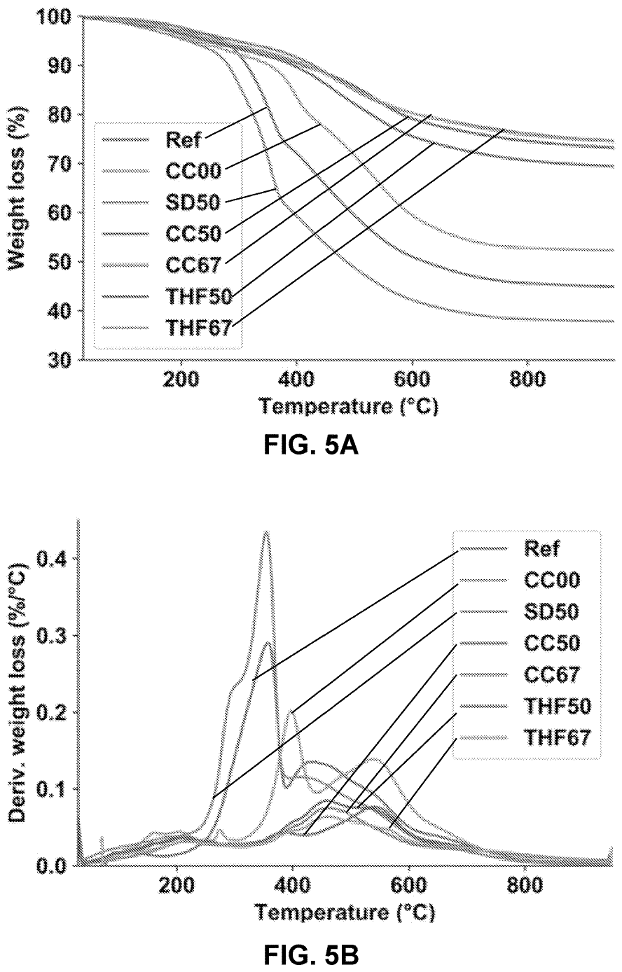

Thermal decomposition behavior and char yield of the selected polymer composites have been characterized by TGA. Phenolic composite produced from commercial resin was named as Ref, and composite using 50% sawdust as a filler combined with pure phenolic resin was named SD50. In general, Ref with low volatile had a high decomposition temperature of 5% weight loss (T₅) but a lower decomposition temperature of 10% weight loss (T₁₀) and a much lower char yield of 44.9% at 950° C. (C₉₅₀) compared to that of the composites with coal char filler, all around 70%. From FIGS. 5A-5B, it was observed that in comparison with the pure resin polymer (CC00), sawdust had a negative effect on the thermal stability of phenolic composites, of which the characteristic thermal data for T₅, T₁₀ and C₉₅₀ as shown in Table 4 was worst among the selected polymer composites. Comparing two different mixing methods with same amount of coal char, THF method lost a bit more weight than powder mixing method at each stage, which could be caused by some trapped solvent, but didn't have a large influence on the thermal resistance of polymers. All the composites with coal char significantly increased the T₅, T₁₀ and the char yield at the end. Also, the decomposition rates of coal char composites were much lower than that of pure polymer (CC00) and the sawdust composite (SD50), and the temperature of highest degradation rate (T_{DTGmax}) occurred at higher temperatures as seen in FIG. 5B. With the same method, more coal char loading increased the thermal stability and char yield of the composites. In summary, coal char is an excellent filler to improve the thermal behavior of composites compared with the common filler like sawdust. The results are inspiring for some potential applications like polymeric ablative materials, which normally produce high char yield matrices when exposed to a nonoxidizing hyperthermal environment and work as thermal insulators for the material inside.³⁸

TABLE 4
Characteristic thermal data of selected polymer composites.

| Composite | T₅ (° C.) | T₁₀ (° C.) | C₉₅₀ (%) | T_{DTGmax} (° C.) |
|---|---|---|---|---|
| Ref | 272.7 | 313.7 | 44.9 | 356.7 |
| CC00 | 223.3 | 352.3 | 52.3 | 397.3 |
| SD50 | 210.1 | 281.1 | 37.8 | 354.1 |
| CC50 | 256.3 | 409.3 | 73.1 | 539.4 |
| CC67 | 294.0 | 429.1 | 74.6 | 460.1 |
| THF50 | 241.4 | 393.4 | 69.3 | 457.4 |
| THF67 | 265.0 | 417.0 | 74.5 | 464.0 |

### Conclusion

Using coal char as a filler in phenolic polymer composites showed a higher stiffness and thermal stabilities compared with conventional commercial composites and sawdust composites.

Two dispersion methods were investigated: powder mixing and solvent dispersion with THF. With powder mixing method, 50% of coal char composite showed best compressive properties while the tensile strength was relatively low. Using THF as a solvent assisted a better dispersibility of coal char in the phenolic resin, which was confirmed by SEM analysis. THF70 showed the highest compressive strength at 307 MPa. THF60 maintained high quality on both compressive and tensile properties, at 288 MPa and 75 MPa, respectively. The compressive strength was 45% higher than Ref and SD50, while the tensile strength was 42% and 19% higher than Ref and SD50, respectively. The thermal behaviors of the composites were considerably improved by adding coal char and produced higher char yield.

### References Corresponding to Example 1

(1) Rahman, M.; Pudasainee, D.; Gupta, R. Review on Chemical Upgrading of Coal: Production Processes, Potential Applications and Recent Developments. Fuel Process. Technol. 2017, 158, 35-56. https://doi.org/10.1016/j.fuproc.2016.12.010.
(2) Gagarin, H.; Sridhar, S.; Lange, I.; Bazilian, M. D. Considering Non-Power Generation Uses of Coal in the United States. Renew. Sustain. Energy Rev. 2020, 124 (March), 109790. https://doi.org/10.1016/j.rser.2020.109790.
(3) Pudasainee, D.; Kim, J. H.; Yoon, Y. S.; Seo, Y. C. Oxidation, Reemission and Mass Distribution of Mercury in Bituminous Coal-Fired Power Plants with SCR, CS-ESP and Wet FGD. Fuel 2012, 93 (2012), 312-318. https://doi.org/10.1016/j.fuel.2011.10.012.
(4) Eterigho-Ikelegbe, O.; Yoro, K. O.; Bada, S. Coal as a Filler in Polymer Composites: A Review. Resour. Conserv. Recycl. 2021, 174 (March), 105756. https://doi.org/10.1016/j.resconrec.2021.105756.
(5) Holberg, S.; Wang, X.; Schaffers, W. C.; Bell, D. A.; Adams, J. J.; Johnson, P. A. Coal-Derived, Solid Resins as Economic Raw Materials for Coatings. J. Coatings Technol. Res. 2021, No. October 2020. https://doi.org/10.1007/s11998-020-00457-7.
(6) Wang, X.; Holberg, S.; Ogunsakin, O. R.; Rainbolt, C.; Hawki, J.; Johnson, P. A. Hydroxyethylated Coal Extract as Polyols for Two-Component Polyurethane Coatings. ACS Appl. Polym. Mater. 2022. https://doi.org/10.1021/acsapm.2c01262.
(7) Jiang, T.; Liu, S.; AlMutawa, F.; Tanner, J. E.; Tan, G. Comprehensive Reuse of Pyrolysis Chars from Coals for Fabrication of Highly Insulating Building Materials. J.

Clean. Prod. 2019, 222, 424-435. https://doi.org/10.1016/j.jclepro.2019.03.048.
(8) BEJARANO, P. A.; LEVENDIS, Y. A. COMBUSTION OF COAL CHARS IN OXYGEN-ENRICHED ATMOSPHERES. Combust. Sci. Technol. 2007, 179 (8), 1569-1587. https://doi.org/10.1080/00102200701239272.
(9) Liu, J.; Li, B.; Zhu, J. Investigation on Pulverized Coal Char Oxy-Combustion Behavior at Moderate and High Temperatures: Experiments and a Novel Developed Kinetics Modeling. Ind. Eng. Chem. Res. 2018, 57 (36), 12264-12277. https://doi.org/10.1021/acs.iecr.8b02428.
(10) Wang, Y.; Tan, S.; Bell, D. A. Steam Gasification of Powder River Basin Coal: Surface Reaction Kinetics and Intraparticle Mass Transfer Restrictions. J. Therm. Anal. Calorim. 2021, No. 0123456789. https://doi.org/10.1007/s10973-020-10407-5.
(11) Wang, J.; Yao, Y.; Cao, J.; Jiang, M. Enhanced Catalysis of K2CO3 for Steam Gasification of Coal Char by Using Ca (OH) 2 in Char Preparation. Fuel 2010, 89 (2), 310-317. https://doi.org/10.1016/j.fuel.2009.09.001.
(12) Gibson, L. J.; Ashby, M. F.; Karam, G. N.; Wegst, U.; Shercliff, H. R. The Mechanical Properties of Natural Materials. II. Microstructures for Mechanical Efficiency. Proc. R. Soc. London. Ser. A Math. Phys. Sci. 1995, 450 (1938), 141-162.
(13) Das, O.; Sarmah, A. K.; Bhattacharyya, D. Nanoindentation Assisted Analysis of Biochar Added Biocomposites. Compos. Part B Eng. 2016, 91, 219-227. https://doi.org/10.1016/j.compositesb.2016.01.057
(14) Cuthbertson, D.; Berardi, U.; Briens, C.; Berruti, F. Biochar from Residual Biomass as a Concrete Filler for Improved Thermal and Acoustic Properties. Biomass and Bioenergy 2019, 120 (February 2018), 77-83. https://doi.org/10.1016/j.biombioe.2018.11.007.
(15) Kane, S.; Van Roijen, E.; Ryan, C.; Miller, S. Reducing the Environmental Impacts of Plastics While Increasing Strength: Biochar Fillers in Biodegradable, Recycled, and Fossil-Fuel Derived Plastics. Compos. Part C Open Access 2022, 8 (March), 100253. https://doi.org/10.1016/j.jcomc.2022.100253.
(16) Danish, A.; Ali Mosaberpanah, M.; Usama Salim, M.; Ahmad, N.; Ahmad, F.; Ahmad, A. Reusing Biochar as a Filler or Cement Replacement Material in Cementitious Composites: A Review. Constr. Build. Mater. 2021, 300 (April), 124295. https://doi.org/10.1016/j.conbuildmat.2021.124295.
(17) Das, C.; Tamrakar, S.; Kiziltas, A.; Xie, X. Incorporation of Biochar to Improve Mechanical, Thermal and Electrical Properties of Polymer Composites. Polymers (Basel). 2021, 13 (16), 1-32. https://doi.org/10.3390/polym13162663.
(18) Fabris, H. J.; Knauss, W. G. Synthetic Polymer Adhesives. Compr. Polym. Sci. Suppl. 1989, 131-177. https://doi.org/10.1016/b978-0-08-096701-1.00208-1.
(19) Noparvar-Qarebagh, A.; Roghani-Mamaqani, H.; Salami-Kalajahi, M.; Kariminejad, B. Nanohybrids of Novolac Phenolic Resin and Carbon Nanotube-Containing Silica Network: Two Different Approaches for Improving Thermal Properties of Resin. J. Therm. Anal. Calorim. 2017, 128 (2), 1027-1037. https://doi.org/10.1007/s10973-016-5970-0.
(20) Pizzi, A.; Ibeh, C. C. Phenol-Formaldehydes; Elsevier Inc., 2014. https://doi.org/10.1016/B978-1-4557-3107-7.00002-6.
(21) Gardziella, A.; Pilato, L. A.; Knop, A. Phenolic Resins: Chemistry, Applications, Standardization, Safety and Ecology (Google EBook); 2000.
(22) Asim, M.; Saba, N.; Jawaid, M.; Nasir, M.; Pervaiz, M.; Y. Alothman, O. A Review on Phenolic Resin and Its Composites. Curr. Anal. Chem. 2017, 13 (October). https://doi.org/10.2174/1573411013666171003154410.
(23) Ma, C. C. M.; Lee, C. T.; Wu, H. Der. Mechanical Properties, Thermal Stability, and Flame Retardance of Pultruded Fiber-Reinforced Poly (Ethylene Oxide)-Toughened Novolak-Type Phenolic Resin. J. Appl. Polym. Sci. 1998, 69 (6), 1129-1136. https://doi.org/10.1002/(SICI) 1097-4628 (19980808) 69: 6<1129::AID-APP10>3.0.CO; 2-O.
(24) Noparvar-Qarebagh, A.; Roghani-Mamaqani, H.; Salami-Kalajahi, M. Functionalization of Carbon Nanotubes by Furfuryl Alcohol Moieties for Preparation of Novolac Phenolic Resin Composites with High Carbon Yield Values. Colloid Polym. Sci. 2015, 293 (12), 3623-3631. https://doi.org/10.1007/s00396-015-3741-2.
(25) Mousavi, A.; Roghani-Mamaqani, H.; Salami-Kalajahi, M.; Shahi, S.; Abdollahi, A. Grafting of Silica Nanoparticles at the Surface of Graphene for Application in Novolac-Type Phenolic Resin Hybrid Composites. Mater. Chem. Phys. 2018, 216 (May), 468-475. https://doi.org/10.1016/j.matchemphys.2018.05.017.
(26) Feng, J.; Li, J.; Chen, L.; Qin, Y.; Zhang, X.; Gu, J.; Tadakamalla, S.; Guo, Z. Enhanced Thermal Stabilities and Char Yields of Carbon Fibers Reinforced Boron Containing Novolac Phenolic Resins Composites. J. Polym. Res. 2017, 24 (11). https://doi.org/10.1007/s10965-017-1338-9.
(27) Tatara, R. A.; Suraparaju, S.; Rosentrater, K. A. Compression Molding of Phenolic Resin and Corn-Based DDGS Blends. J. Polym. Environ. 2007, 15 (2), 89-95. https://doi.org/10.1007/s10924-007-0052-9.
(28) DeArmitt, C. Functional Fillers for Plastics. Appl. Plast. Eng. Handb. Process. Mater. 2011, 455-468. https://doi.org/10.1016/B978-1-4377-3514-7.10026-1.
(29) Habel, K.; Viviani, M.; Denarié, E.; Brühwiler, E. Development of the Mechanical Properties of an Ultra-High Performance Fiber Reinforced Concrete (UHPFRC). Cem. Concr. Res. 2006, 36 (7), 1362-1370. https://doi.org/10.1016/j.cemconres.2006.03.009.
(30) Rossi, P.; Arca, A.; Parant, E.; Fakhri, P. Bending and Compressive Behaviours of a New Cement Composite. Cem. Concr. Res. 2005, 35 (1), 27-33. https://doi.org/10.1016/j.cemconres.2004.05.043.
(31) Vinayagamoorthy, R. Effect of Particle Sizes on the Mechanical Behaviour of Limestone-Reinforced Hybrid Plastics. Polym. Polym. Compos. 2020, 28 (6), 410-420. https://doi.org/10.1177/0967391119883163.
(32) Nwanonenyi, S. C.; Obidiegwu, M. U.; Onuegbu, G. C. Studies on the Properties of Linear Low Density Polyethylene Filled Oyster Shell Powder. Int. J. Eng. Sci. 2013, 2 (2), 1-8.
(33) Nourbakhsh, A.; Karegarfard, A.; Ashori, A.; Nourbakhsh, A. Effects of Particle Size and Coupling Agent Concentration on Mechanical Properties of Particulate-Filled Polymer Composites. J. Thermoplast. Compos. Mater. 2010, 23 (2), 169-174. https://doi.org/10.1177/0892705709340962.
(34) Lee, M. G.; Lee, S.; Cho, J.; Jho, J. Y. Improving Dispersion and Mechanical Properties of Polypropylene/Graphene Nanoplatelet Composites by Mixed Solvent-Assisted Melt Blending. Macromol. Res. 2020, 28 (12), 1166-1173. https://doi.org/10.1007/s13233-020-8144-7.
(35) Ma, Y. Y.; Wang, H. H.; Mo, W. L.; Zhang, X. Y.; Fan, X.; Ma, J.; Ma, F. Y.; Wei, X. Y. Effect of Swelling by Organic Solvent on Structure, Pyrolysis, and Methanol Extraction Performance of Hefeng Bituminous Coal. ACS Omega 2021, 6 (23), 14765-14773. https://doi.org/10.1021/acsomega.0c06105.
(36) Dahal, R. K.; Acharya, B.; Saha, G.; Bissessur, R.; Dutta, A.; Farooque, A. Biochar as a Filler in Glassfiber Reinforced Composites: Experimental Study of Thermal and Mechanical Properties. Compos. Part B Eng. 2019, 175 (July), 107169. https://doi.org/10.1016/j.compositesb.2019.107169.
(37) Li, J. C.; Zheng, L. F.; Sha, X. H.; Chen, P. Microstructural and Mechanical Characteristics of Graphene Oxide-Fly Ash Cenosphere Hybrid Reinforced Epoxy Resin Composites. J. Appl. Polym. Sci. 2018, 47173 (November 2018), 1-8. https://doi.org/10.1002/app.47173.
(38) Natali, M.; Rallini, M.; Torre, L.; Puglia, D. High Temperature Composites From Renewable Resources: A Perspective on Current Technological Challenges for the Manufacturing of Non-Oil Based High Char Yield Matrices and Carbon Fibers. 2022, 9 (March), 1-22. https://doi.org/10.3389/fmats.2022.805131.

### Example 2: Curing Kinetics of Phenolic Resin/Coal Char Composites

Curing behavior plays a key role in determining ultimate properties of thermosetting polymers. It may be influenced by adding a filler or reinforcement to polymer resin. The effect of filler on curing kinetics of thermosetting-based composites was investigated. The curing process of novel phenolic composites reinforced with., coal char using non-isothermal DSC measurements was studied. Curing kinetics were analyzed by model-free isoconversional methods for determining kinetic parameters. According to the results, highly filled composites (containing 50 wt. % coal char) showed higher activation energy, indicating the retardation effect of coal char on the curing of phenolic resin. The curing reaction was also influenced by the processing method of the composite.

### Experimental Materials

The phenolic resin used in this work (GP 5520 PARAC) was provided by Georgia-Pacific Chemicals LLC, USA. Coal char was obtained from Atlas Carbon, USA. The coal char was produced by heating Powder River Basin (PRB) coal at high temperature (850° C.). THF (99.9%) was purchased from Sigma Aldrich and used as received.

### Preparation of the Phenolic Resin/Coal Char Composites

Coal char powder with a particle size of sub 40 microns was prepared by ball-milling and sieving. It was then dehydrated in a vacuum oven at 80° C. overnight. To prepare phenolic resin/coal char composites, two different processing methods were employed. In the first method, phenolic resin and coal char powders were mixed in a shaker to obtain a molding compound. For the second composite, phenolic resin was first dissolved in THF by mixing for 3 h. After that, coal char was added to the solution and the suspension was mixed at room temperature for 30 min, followed by removing the solvent in a vacuum oven at 70° C. for 20 h. In both composites, phenolic resin to coal char weight ratio was 1:1. The samples for DSC measurements are designated as PR (phenolic resin), PR/CC (phenolic resin/coal char composite prepared by dry mixing), and PR/CC-s (phenolic resin/coal char composite prepared by mixing in THF).

### Characterization

To study non-isothermal curing of the phenolic resin and corresponding composites, differential scanning calorimetry (DSC) measurements were performed using a TA instruments DSC 250. The samples (5-6 mg) were enclosed in aluminum pans and heated from room temperature to 250° C. at different heating rates (3, 5, 7, and 10° C./min) under N₂ atmosphere. The thermal analysis data were then used to analyze curing kinetics of the samples.

### Dynamic DSC

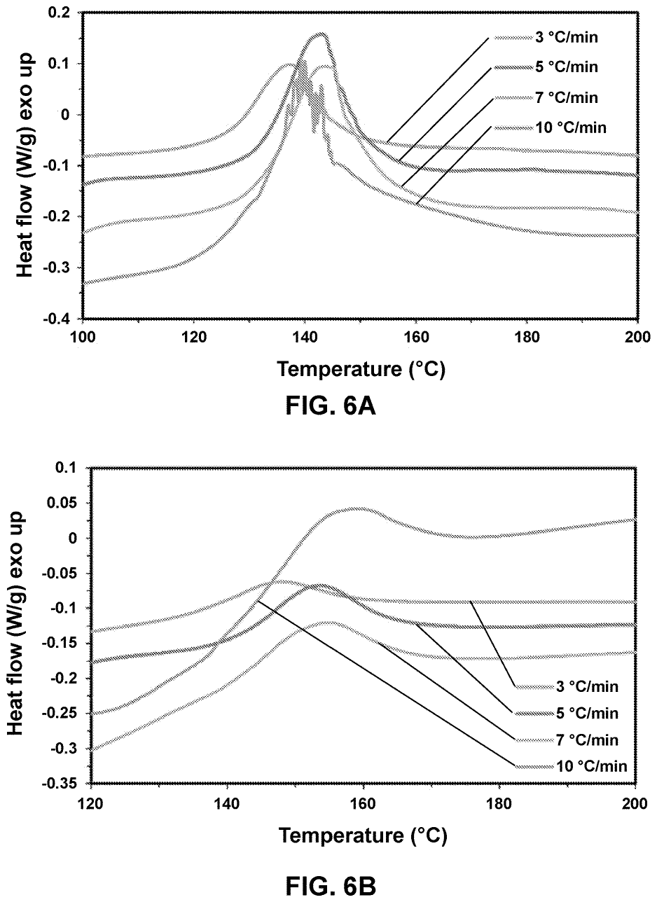

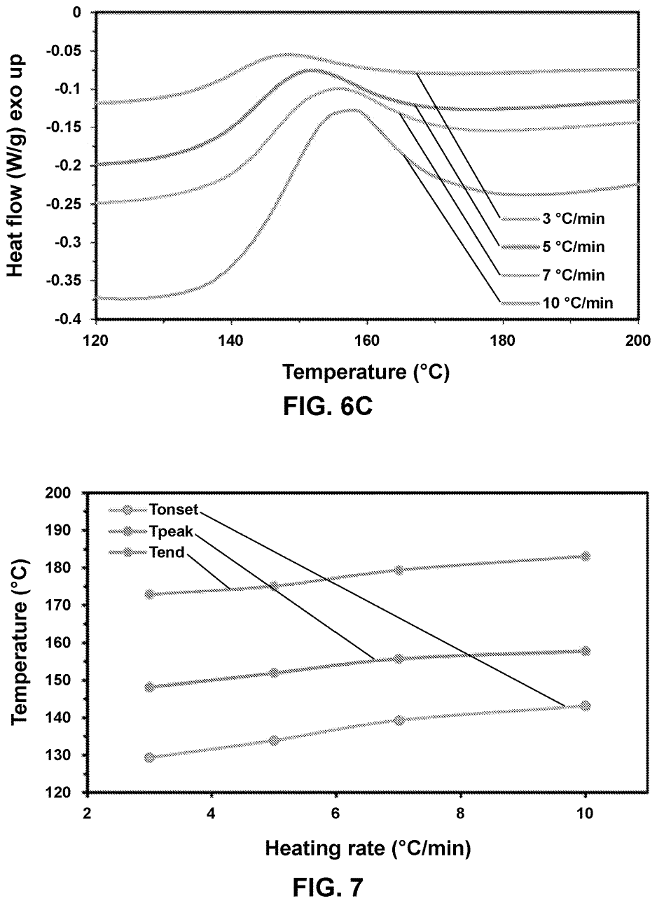

The DSC thermograms of the phenolic resin and the composites at different heating rates (3-10° C./min) are shown in FIGS. 6A-6C. Curing characteristics including onset temperature (Tₒₙₛₑₜ), peak temperature (Tₚ), end temperature (T_{end}), and heat of reaction (ΔH) are also summarized in Table 5. Phenolic resin showed an exothermic peak with an average heat of reaction of 44.7 J/g. At the same heating rate, onset temperature, peak temperature, and end temperature shifted to higher temperatures with incorporation of coal char into the resin, while heat of reaction decreased. For example, when the heating rate is 3° C./min, Tₒₙₛₑₜ of the PR, PR/CC, and PR/CC-s are 107.7° C., 128.7° C., and 129.3° C., respectively. It indicates that adding 50 wt. % of coal char may retard curing of phenolic resin. In fact, at such a high loading, coal char particles can prevent functional groups from neighboring chains to react, thereby leading to an increase in curing temperature. On the other hand, the curing peak of the phenolic resin is much wider compared to those of the composites. In fact, average temperature range of curing (ΔT=T_{end}−Tₒₙₛₑₜ) is around 63° C. for PR, while it is 40° C. and 41° C. for PR/CC, and PR/CC-s, respectively. An interesting observation is that even though curing process in the composites starts at higher temperatures, but T_{end} of the phenolic and the composite are close to each other, especially at heating rates >3° C./min. The role of coal char during curing of phenolic will be discussed in detail in the next sections.

TABLE 5
Curing characteristics of the phenolic
resin and phenolic/coal char composites.

| | Heating rate | Tₒₙₛₑₜ | Tₚ | T_{end} | ΔH |
|---|---|---|---|---|---|
| Sample | (° C./min) | (° C.) | (° C.) | (° C.) | (J/g) |
| PR | 3 | 107.7 | 137.2 | 166.5 | 53.2 |
| | 5 | 110.5 | 142.9 | 170.9 | 46.4 |
| | 7 | 115.9 | 143.8 | 178.6 | 40.9 |
| | 10 | 121.1 | — | 189.8 | 38.3 |
| PR/CC | 3 | 128.7 | 147.4 | 170.5 | 15.8 |
| | 5 | 133.3 | 153.2 | 173.7 | 14.6 |
| | 7 | 137.5 | 154.1 | 176.5 | 12.6 |
| | 10 | 142.7 | 159.1 | 180.9 | 12.3 |
| PR/CC-s | 3 | 129.3 | 148.1 | 172.9 | 16.6 |
| | 5 | 133.9 | 151.9 | 175.1 | 18.0 |
| | 7 | 139.3 | 155.7 | 179.4 | 15.1 |
| | 10 | 143.2 | 157.8 | 183.1 | 16.4 |

According to data in Table 5, the average ΔH of the PR, PR/CC, and PR/CC-s are 44.7, 13.8, and 16.5 J/g, respectively. The decrease in the heat of reaction can be ascribed to lower weight percentage of phenolic resin in the composites.

From the DSC thermograms, the exothermic peak shifts towards higher temperatures with increasing heating rate (β) for all studied samples. This is resulted from thermal lag effect which retards curing of phenolic.

To calculate gel temperature (T⁰ₒₙₛₑₜ), optimal curing temperature (T⁰ₚ), and end temperature (T⁰_{end}), the values of Tₒₙₛₑₜ, Tₚ and T_{end} of the samples were plotted as a function of β, and the curves were extrapolated to β=0. A representative curve for the PR/CC-s composite is illustrated in FIG. 7 and the calculated values for all samples are listed in Table 6. According to the results, gel temperature of the phenolic resin and PR/CC and PR/CC-s composites are 101.4° C., 123.1° C., and 123.8° C., respectively. Furthermore, optimal curing temperature of the above-mentioned systems are 133.1° C., 143.7° C., and 144.7° C., respectively. As seen, Top increases in the presence of 50 wt. % coal char. These data provide useful information about optimal processing parameters for the curing of phenolic resin and corresponding composites reinforced with coal char.

TABLE 6
T⁰ₒₙₛₑₜ, T⁰ₚ, and T⁰_{end} of the samples

| | T⁰ₒₙₛₑₜ | T⁰ₚ | T⁰_{end} |
|---|---|---|---|
| Sample | (° C.) | (° C.) | (° C.) |
| PR | 101.4 | 133.1 | 155.2 |
| PR/CC | 123.1 | 143.7 | 166.2 |
| PR/CC-s | 123.8 | 144.7 | 168.2 |

### Analysis of Curing Kinetics

### Degree of Conversion

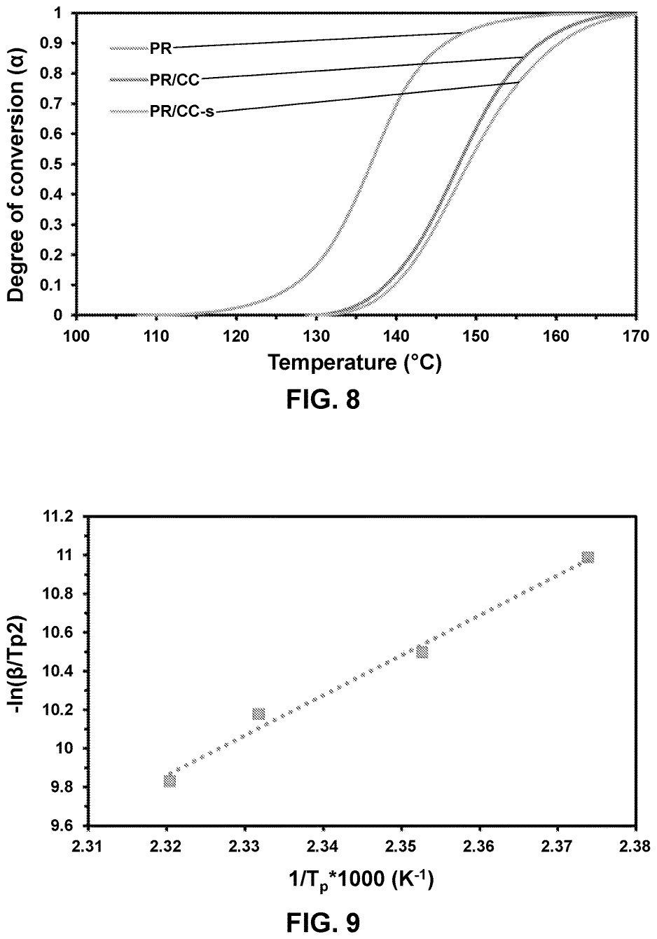

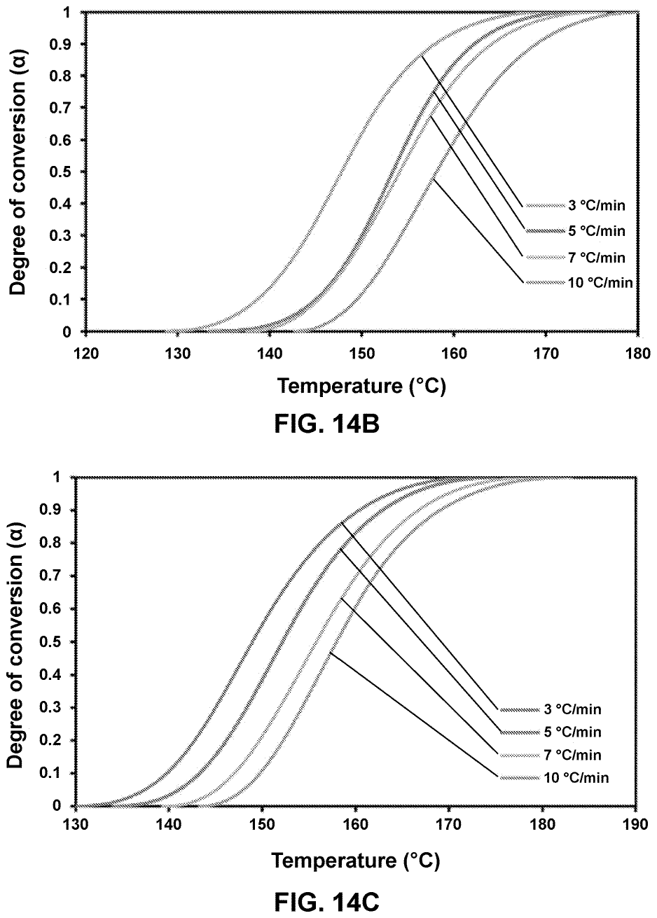

Degree of conversion (a) during curing of a thermosetting resin is expressed as:

$$α = \frac{Δ {H}_{T}}{Δ {H}_{c u r e}} \qquad ( Eq . 1 )$$

where ΔH_{T} is the heat generated between beginning of curing and temperature T, and ΔH_{cure} is the total heat of reaction. FIG. 8 compares the relationship between degree of conversion and temperature at heating rate of 3° C./min for the unfilled and filled resins. For all samples, degree of conversion increased rapidly and finally reached to a plateau. A series of branching and chain extension take place during curing of phenolic resin which ultimately leads to limited mobility of the reactive sites and low rates. From the figure, degree of conversion is lower at a certain temperature upon adding coal char to the phenolic resin. For instance, a is about 35% and 42% lower at 150° C. for the PR/CC and PR/CC-s composites compared to PR. As explained earlier, it is due to the retardation effect of the coal char on the curing of this thermosetting resin. PR/CC-s sample shows a delay in reaching to a certain degree of conversion compared to PR/CC, indicating the fact that processing method can change curing behavior through affecting dispersion of coal char in the polymer matrix. As shown in FIGS. 14A-14C, the degree of conversion also shifted to higher temperatures for all samples with increasing heating rate.

### Activation Energy

Having a comprehensive understanding of the kinetics of the curing reaction is of great importance in designing formulations of phenolic systems with optimal performance. Activation energy (E) is a key parameter in the study of curing reaction of thermosetting resins and composites. In this research, two isoconversional methods, i.e., Kissinger and Starink were used to obtain the activation energy of curing of the samples.

First, the Kissinger equation (Eq. 2) was employed to calculate average activation energy of curing reaction of the phenolic resin and phenolic/coal char composites. The Kissinger equation is expressed as:

$$- ln ( \frac{β}{{T}_{p}^{2}} ) = - ln ( \frac{A R}{E} ) + \frac{E}{R {T}_{p}} \qquad ( Eq . 2 )$$

In this equation, β is heating rate (° C./min), Tₚ is peak temperature (K), A is pre-exponential factor (min-1), R is the gas constant (8.314 J/mol·K), and E is the activation energy (J/mol). This way, average activation energy can be estimated by plotting-ln(β/T) versus 1/Tₚ. A representative figure illustrating the plot for the PR/CC-s composite is shown in FIG. 9. From slope of the fitting line, E_{avg} for the PR, PR/CC, and PR/CC-s are equal to 120.3 KJ/mol, 151.1 KJ/mol, and 172.5 KJ/mol, respectively.

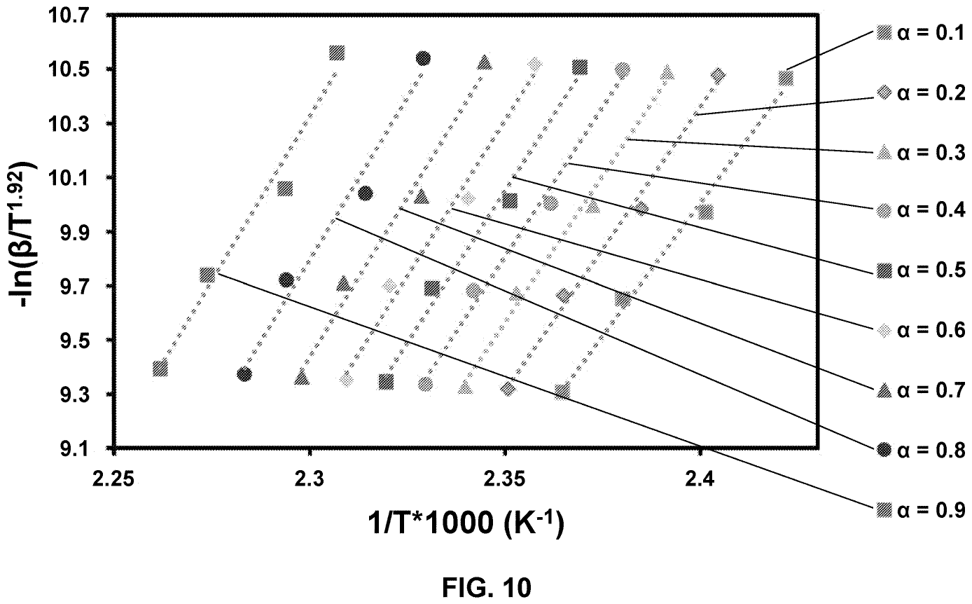

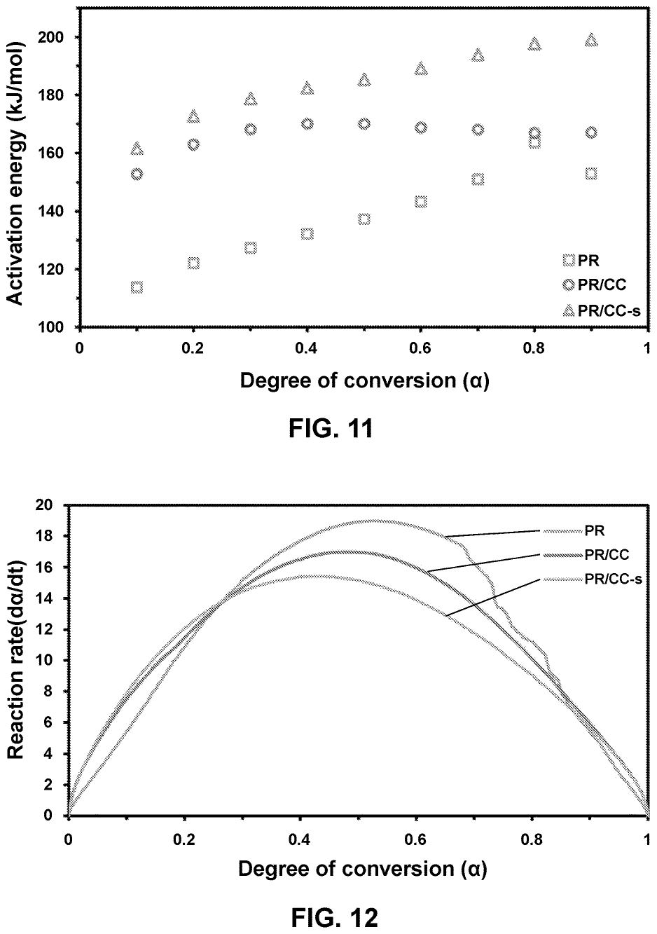

To evaluate variation of activation energy at various degrees of conversion, Starink method was employed. In this method, the following equation is used:

$$- ln ( \frac{β}{{T}_{α}^{1.92}} ) = - const + 1.008 \frac{{E}_{α}}{R {T}_{α}} \qquad ( Eq . 3 )$$

where T_{α} is the temperature at a certain degree of conversion (α) at a particular β and E_{α} is the activation energy at the particular α. We obtained E_{α} values at different degrees of conversion by plotting ln(β/T^{1.92}) versus 1/T. FIG. 10 depicts the Starink plots for the PR/CC-s composite. Also, FIG. 11 shows activation energy as a function of degree of conversion for the neat resin and coal char-filled phenolic composites. A progressive increase in the activation energy can be observed for the PR sample. This increase is owing to the increase in the density of crosslinks and viscosity of polymer during curing process which constraint chain mobility and diffusion phenomenon. In other words, there is a large energy barrier for longer chains and larger networks. The phenolic/coal char composites showed a similar behavior. However, adding this filler to the phenolic matrix led to higher activation energy during curing compared to the neat phenolic. To explain this observation, the following phenomena should be considered:

### Thermal Conductivity:

Incorporation of coal char improves thermal conductivity of the polymer matrix, resulting in reduction of energy barrier and activation energy of curing.

### Viscosity/Steric Hindrance:

Blending phenolic resin with fillers like coal char significantly increases viscosity of the matrix, which in turn slows down the curing reaction. On the other hand, coal char particles can hinder reactive species from accessing each other. Besides, coal char particles have many pores that can possibly trap polymer chains. This also negatively affects curing reaction.

It appears that at high loadings, negative effects of coal char on curing of phenolic resin including steric hindrance and increase in viscosity are much stronger than its positive effect, i.e. improving thermal conductivity of the matrix. Thus, accelerating effect that has been reported for resins reinforced with low content of fillers such as carbon nanotubes, was not observed in the present study. Instead, the results revealed retardation effect of the filler on the curing process of phenolic in the composites containing 50 wt. % of coal char.

Comparison of the variation of E_{α} vs α for the PR/CC and PR/CC-s shows that there is a difference between activation energy values of these two composites. This difference starts to grow at conversions higher than 0.4. The composite prepared by solution technique (PR/CC-s) have higher E_{α} than the one prepared by powder mixing method (PR/CC). To interpret this observation, we should focus on the aforementioned factors. It is expected that filler particles are smaller and the coal char dispersion in the polymer matrix is more homogenous in the case of the PR/CC-s compared to PR/CC. Smaller particles can increase viscosity more rapidly than coarse ones. They also can apply stronger steric effect on the phenolic chains, while conductivity is much better in more homogenous dispersions. We believe that the solution technique can provide a better mixing, and thereby stronger interaction between phenolic chains and coal char particles which is desirable for enhancing mechanical properties. However, it can't accelerate curing process owing to the reasons discussed above.

### Kinetic Model of the Curing

Curing kinetics of thermosetting polymers can be classified into two major categories: n-th order and autocatalytic. Analysis of dependency of reaction rate (dα/dt) on degree of conversion (α) can provide valuable information on the kinetic model, the impact of adding coal char, etc. The dα/dt vs. α curves are depicted in FIG. 12. For the phenolic resin and composites, the reaction rate exhibited zero values at initial and final stages of curing and reached to a maximum at some intermediate degree of conversion, indicating all these systems obeyed autocatalytic kinetics. Thus, we can conclude that the addition of coal char to phenolic does not change curing reaction mechanism of the resin. According to the curves, it is evident that reaction rate of the phenolic is higher than those of the coal char-filled composites.

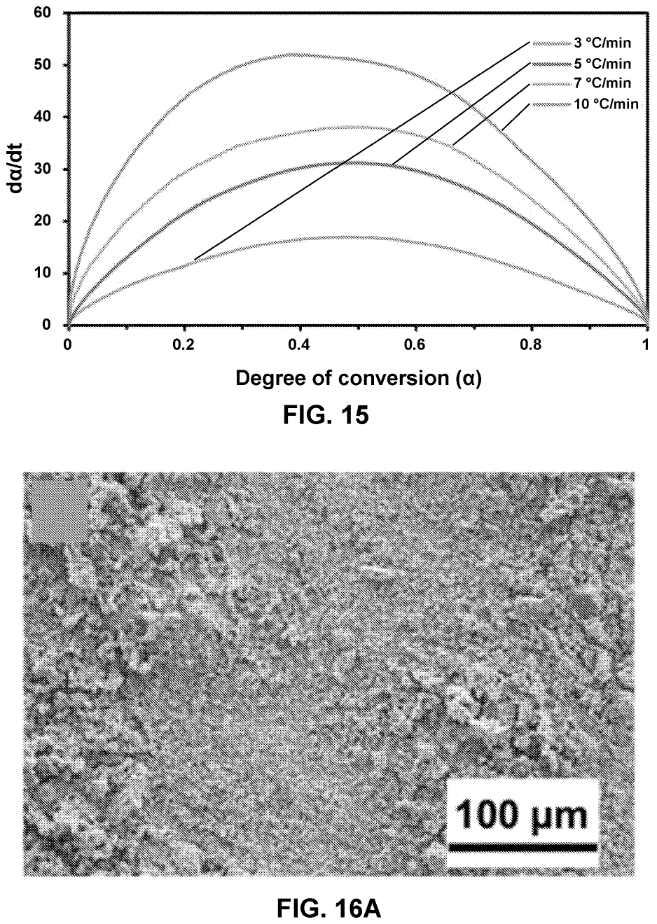

The dα/dt vs. α plots at various heating rates for the PR-CC composite are presented as FIG. 15. Increasing the heating rate promoted curing of phenolic and higher reaction rates were obtained. However, maximum value of dα/dt slightly changed implying the fact that heating rate did not affect curing mechanism.

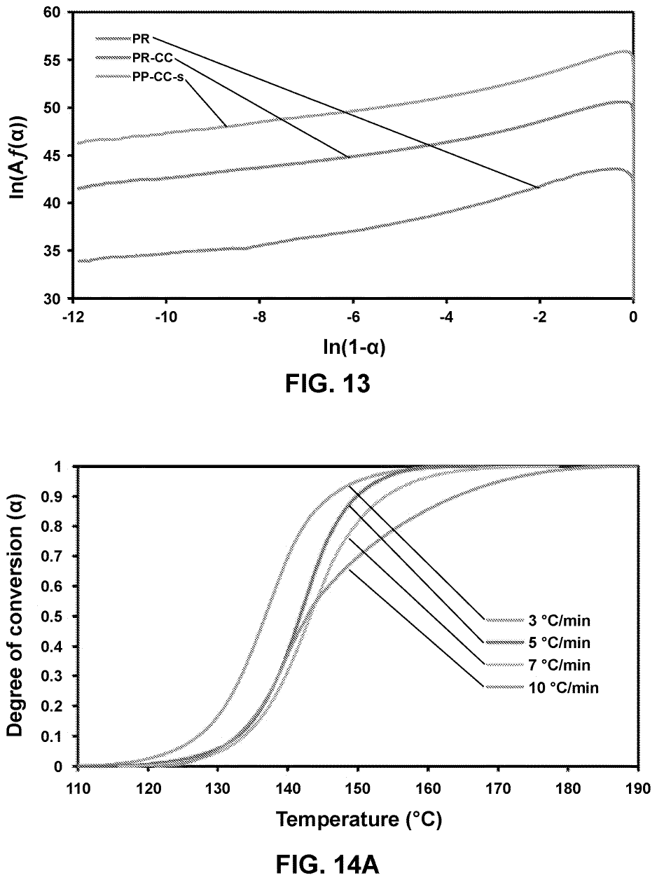

The kinetic model of curing can be further corroborated using Friedman method. According to this method, equation 4 and relationship between ln(Af(α)) and ln(1−α) is used to determine kinetic model of a reaction.

$$ln ( A f ( α ) ) = ln A + n ln ( 1 - α ) \qquad ( Eq . 4 )$$

where f(α) is the conversion function. To obtain ln(Af(α)) values, we used the following equation:

$$ln ( \frac{d α}{d t} ) = ln ( A f ( α ) ) - \frac{{E}_{α}}{R T} \qquad ( Eq . 5 )$$

Where E_{α} is the average activation energy calculated using Starink method. The ln(Af(α)) vs ln(1−α) plots are illustrated in FIG. 13. The plots of the phenolic and phenolic/coal char composites showed a maximum in ln(1−α)=0.2-0.5 which is equivalent to a degree of conversion of 0.2-0.4, suggesting that curing reaction of all samples are autocatalytic.

### Conclusions

In this work, two phenolic/coal char composites were prepared, and their curing kinetics were compared with unfilled phenolic resin. DSC technique in non-isothermal mode was employed to study curing process of the samples at different heating rates. Incorporation of the coal char into the phenolic led to an increase in onset temperature, peak temperature, and end temperature of the curing. Also, the composites showed higher activation energy than that of pure phenolic resin. It was attributed to an increase in viscosity and steric effect caused by coal char which provides a higher energy barrier for the curing of the composites. The composited prepared by solution method (PR-CC-s) did not have any accelerating effect on the curing process. Instead, PR-CC-s showed higher activation energy than the other composite prepared by powder mixing technique (PR-CC), especially at high conversion rates. It appears that particle size of the filler and dispersion of the coal char in the polymer matrix can be affected by changing processing method, which in turn changes the kinetics of curing of the phenolic composite.

### Example 3—Resin Types, Solvents, and Particulate Sizes

Various types of resins, solvents, and particulate sizes were investigated. Samples 1 and 15-17, below. correspond to the prior art.

Sample 3, as compared to samples 15 and 16, shows the higher compressive strength and lower volatile matter content when using coal char as filler as compared to coal or saw dust.

In terms of dissolving the resin first, then blending with the coal char, then removing the solvent (as compared to simple dry mixing), samples 6 to 14 are inventive. But only samples 6-11, using THF as dispersion solvent, provided improved strength as compared to dry mixing with the present phenolic resin. This may be different when using another resin. Sample 8 as compared to sample 5 shows the significantly higher compressive strength and lower water absorption at a high filler load of 67% char when using the solvent method instead of dry mixing.

Samples 28-30 show use coal char from flash pyrolysis. As compared to samples 3 and 4 (several hours pyrolysis), samples 28-30 show lower strength. Yet they show that it works in principle.

Quantities provided represent the proportions of the applied materials, not necessarily the exact batch size.

### Methods

Dry mixing: All components were blended for 2 min using a vortex mixer.

Solvent method: The phenolic resin is dissolved in the solvent. For all tested solvents, a clear solution with a small fraction (1-2%) of un-dissolved particles was obtain. Coal char is then added to the solution, and the mixture is stirred in a dissolver at 3000 rpm for 10 min. The solvent is removed by drying, first in a ventilated oven for about 2 h at 70° C., then in a vacuum oven at 0.5 mbar/70° C. for about 12 h.

Compression molding: For compression molding, stainless steel molds consisting of upper and lower part were used.

Rectangular mold: Lower part consisted of a bottom plate, 145×115×10 mm, connected with 18 4 mm screws to a frame, height 2.5 mm, outer dimensions 145×115 mm, inner cavity 120×90 mm. Upper part is a block that fits into the inner cavity (thus, its dimensions are minimally smaller than the cavity) of 25 mm height, connected to a top plate the size of the bottom plate. The mold molds a flat phenolic resin plate the size of the inner cavity with its thickness controlled by the amount of resin added.

Cylindrical mold: Lower part consisted of a bottom plate, 51×38×10 mm, connected with each 3 4 mm screws to two blocks, 51×19 mm, 44 mm high. The two blocks are connected with 6 4 mm screws. The two blocks together form a vertical cylindrical cavity of 8 mm diameter with each block comprising a semicircle. Upper part is a cylinder, 44 mm high that fits into the cavity. Thus, its diameter is minimally smaller. The cylinder is connected to a cylindrical top plate, height 6 mm, diameter 22 mm. The mold molds a cylinder of 8 mm diameter with its height controlled by the amount of resin added.

Molding process: Prior to loading the molds, the surfaces were treated with Thermoset Mold Release spray from Slide products, a hydrocarbon-based mold release agent. The lower part of the molds was loaded with resin, the upper part was put on top, and the complete mold was put into a hot press (Carver model 3912). Top and bottom platen of the hot press were pre-heated to 160° C., so the heat is transferred to top and bottom of the mold. The manual, hydraulic pump of the hot press is used to apply a force which is regularly adjusted, as shrinkage and flow otherwise would reduce the initial pressure. Force, calculated pressure on cavity and duration: Rectangular mold: 80 KN, 7.4 MPa, 40 min. Cylindrical mold: 1335 N, 26.5 MPa, 25 min.

### Mechanical Testing

Compressive strength and compressive modulus of elasticity were determined according to ASTM-D695-15 on 5 cylindrical specimen for each material (unless stated otherwise). The sample size was reduced to 8 mm diameter and 16+2 mm height to match the force limits of the used load frame. Test speed was 1 mm/min. Specimen were used as molded.

For tensile testing, samples according to ASTM D638-14, type 5 specimen were prepared by waterjet cutting of a molded plate with a thickness of 3 to 4 mm. Each 5 specimen were tested according to ASTM D638-14, but with the test speed of 0.5 mm/min to avoid breakage prior to 30 s test time. For a few, more brittle samples, the test speed needed to be reduced to 0.1 mm/min.

All compressive and tensile tests showed brittle fractures, thus no significant yielding.

Thermo-gravimetric analysis (TGA)

For TGA, cured resins were ground in a mortar to obtain a powder. TGA data stem from one single run.

TGA—standard: Sample size 10-20 mg, method: Argon flow, isothermal 5 min (about 30° C.), ramp 10° C./min to 950° C., isothermal 2 min, equilibration at 750° C., switch to Oxygen flow, ramp 10° C. to 950° C. To disregard from moisture, the weight at 120° C. during the ramp was set to 100%. Volatile matter was determined as the weight loss after the 2 min isothermal at 950° C., fixed carbon as the weight loss when switching to Oxygen and heating to 950° C., ash as remaining difference to 100%.

TGA—Oxygen: Oxygen flow, ramp 10° C./min to 950° C. The ignition temperature is determined as significant anomaly of the temperature curve (together with drastic weight loss)

### Water Absorption

Water absorption was tested according to ASTM D570. Samples (30×10 mm), cut from plates with 3-4 mm thickness made in the rectangular mold, were oven-dried for 1 h at 110° C. and weighed. Thereafter, the samples were submerged in water for 2 h and 24 h, respectively, dried with a paper tissue, and instantly weighed to determine the relative weight gain after as compared to the dry sample prior to testing.

### Materials:

Coal: Subbituminous coal from the Cordero Rojo mine, Wyoming, USA. The coal was dried in a vacuum oven at 150° C./30 mbar for 12 h to remove moisture, ground in a ball mill and sieved. The fraction <80 μm was used. TGA standard analysis showed 42.2% volatile matter, volatile, 51.6% fixed carbon and 62% ash.

Coal char 1: The coal char was obtained by heating subbituminous coal from the Cordero Rojo mine, Wyoming, USA in a batch process to 850° C. for several hours. The final process atmosphere was inert. The char was ground in a ball mill and sieved. The fraction <80 μm was used. As the char was stored in contact with air, it's moisture content (as weight loss after 12 h at 80° C.) was 5%. TGA standard analysis showed 14.9% volatile matter, 71.5% fixed carbon and 13.6% ash. TGA Oxygen showed the pure coal char powder to ignite at 288° C.

Coal char 2: The coal char was prepared by heating a flow of coal particles (250-425 μm) in an inert gas stream to 900° C. The time the particles are hot is less than 2 s. TGA standard analysis showed 17% volatile matter, 70% fixed carbon and 13% ash.

Coal char 3: Prepared by grinding and sieving coal char 2 to a particle size <80 μm

Phenolic 1: GP 5520 PARAC Phenolic resin from Georgia-Pacific Chemicals, or Bakelite 5520 from Bakelite Synthetics (name change, same product). The product is marketed for various applications, including the use as molding resin. The product is a fine powder; the particle fraction >74 μm is 6%. It is a phenol formaldehyde resin of novolak type containing 7-9% methenamine as crosslinker and is free of fillers. Hot plate cure time is 65 to 85 s at 150° C., inclined plate flow is 30 to 60 mm at 125° C.

Phenolic 2: Black phenolic powder from Sturbridge Metallurgical Services Inc. The resin is intended to be used as hot-mounting resin for microscopic samples and was herein used as commercial reference. It is a phenol-formaldehyde resin of novolak type with crosslinker and fillers. Used fillers are not specified, the safety datasheet mentions the following ingredients and possible fillers with CAS no.: Phenol formaldehyde resin [9003-35-4] 30-60%, Methenamine [100-97-0] 2-15%, Phenol [108-95-2]<3.5%, Formaldehyde [50-00-0]<0.1%; Calcium hydroxide [1305-62-0] 0-10%; Carbon black [1333-86-4] 0-12%, Coal dust 0-18%, Graphite (natural) [7782-42-5] 0-40%, Kaolin [1332-58-7] 0-40%, Mica [12001-26-2] 0-60%, Talc [14807-96-6] 0-20%, wood flour 0-60%

Phenolic 3: Phenolic 3 was prepared from Alnovol PN 320/PAST phenolic resin from Allnex, softening point (ASTM D 6090) 108 to 120° C., free phenol content <=0.3%. The product is marketed for use in rubber or coatings. The resin is supplied as pastilles and is a phenol formaldehyde resin of novolak type without crosslinking agent or fillers, a softening point (ASTM D 6090) of 108 to 120° C. and a free phenol content <=0.3%. Phenolic 3 was obtained by grinding 9 g Alnovol PN 320 pastilles in a mortar to a powder, then adding 1 g methenamine (hexamethylenetetramine) as crosslinking agent and blending the two powders in a mortar.

Saw dust: Wood flower fine saw dust, dried, sifted, from Shannon's Sawmill. Most of the saw dust passes a 150 μm sieve. Moisture content (as weight loss after 12 h at 80° C.) was 6.7%.

Some sample numbers of example 3 correspond with denominators of identical samples of example 1:1=CC00, 2=CC40, 3=CC50, 4=CC60, 5=CC67, 6=THF50, 7=THF60, 8=THF67, 9=THF70, 10=THF75, 11=THF80, 15=SD50, 17=Ref or Commercial Reference.

In Table 7, below, sample 1 is the pure resin and samples 2 to 5 were prepared by dry mix method.

TABLE 7

| Sample | 1 | 2 | 3 | 4 | 5 |
|---|---|---|---|---|---|
| Phenolic 1 | 100 | 60 | 50 | 40 | 33 |
| (g) | | | | | |
| Coal char 1 | — | 40 | 50 | 60 | 67 |
| (g) | | | | | |
| Compressive | 149 ± 12 | 223 ± 9 | 246 ± 9 | 194 ± 11 | 116 ± 6 |
| strength | | | | | |
| (MPa) | | | | | |
| Compressive | 3.6 ± 0.2 | 4.8 ± 0.2 | 5.0 ± 0.4 | 4.8 ± 0.3 | 3.6 ± 0.2 |
| elastic | | | | | |
| modulus | | | | | |
| (GPa) | | | | | |
| Tensile | 28 ± 3 | 37 ± 1 | 31 ± 2 | 17 ± 5 | 8 ± 0 |
| strength | | | | | |
| (MPa) | | | | | |
| Volatile | 46.6 | — | 26.3 | — | 24.9 |
| matter | | | | | |
| (TGA, %) | | | | | |
| Fixed carbon | 52.9 | — | 66.1 | — | 64.8 |
| (TGA, %) | | | | | |
| Ash (TGA, | 0.4 | — | 7.6 | — | 10.3 |
| %) | | | | | |
| Ignition | 540 | — | 446 | — | 442 |
| (TGA, ° C.) | | | | | |
| Water | ≈0.0 | — | 0.1 | 1.0 | 7.6 |
| absorption | | | | | |
| (2 h, %) | | | | | |
| Water | 0.2 | — | 0.4 | 2.6 | 9.5 |
| absorption | | | | | |
| (24 h, %) | | | | | |

A single cylinder according to sample 5 was heated in inert gas (Argon) in a tube furnace with a 2 h ramp to 850° C., then 1 h isothermal a 850° C., then cooling to room temperature. Its maintained compressive strength was 12.2 MPa.

Samples 6 to 11, shown in Table 8 below, were prepared by solvent method using tetrahydrofuran (THF) as solvent.

TABLE 8

| Sample | 6 | 7 | 8 | 9 | 10 | 11 |
|---|---|---|---|---|---|---|
| Phenolic 1 (g) | 50 | 40 | 33 | 30 | 25 | 20 |
| Coal char 1 (g) | 50 | 60 | 67 | 70 | 75 | 80 |
| Compressive strength | 248 ± 10 | 288 ± 8 | 292 ± 6 | 307 ± 10 | 212 ± 4 | 116 ± 4 |
| (MPa) | | | | | | |
| Compressive elastic | 4.4 ± 0.3 | 5.0 ± 0.1 | 5.0 ± 0.1 | 5.4 ± 0.2 | 4.9 ± 0.1 | 4.3 ± 0.1 |
| modulus (GPa) | | | | | | |
| Tensile strength (MPa) | 54 ± 2 | 75 ± 5 | 55 ± 6 | 37 ± 4 | 28 ± 5 | 11 ± 3 |
| Volatile matter (TGA, %) | 29.8 | — | 24.6 | — | — | 22.0 |
| Fixed carbon (TGA, %) | 63.2 | — | 65.1 | — | — | 67.0 |
| Ash (TGA, %) | 7.0 | — | 10.3 | — | — | 11.1 |
| Ignition (TGA, ° C.) | 467 | — | 410 | — | — | 335 |
| Water absorption (2 h, | 0.1 | 0.1 | 0.7 | — | — | 6.0 |
| %) | | | | | | |
| Water absorption (24 h, | 0.3 | 0.3 | 1.9 | — | — | 10.0 |
| %) | | | | | | |

Samples 12-14, shown in Table 9 below, were prepared by solvent method from 50 g Phenolic 1 and 50 g Coal char 1.

TABLE 9

| Sample | 12 | 13 | 14 |
|---|---|---|---|
| Solvent used | Methanol | Ethanol | Acetone |
| Compressive strength | 153 ± 8 | 173 ± 5 | 181 ± 12 |
| MPa) | | | |
| Compressive elastic | 4.7 ± 0.1 | 4.9 ± 0.2 | 5.1 ± 0.1 |
| modulus (GPa) | | | |

Table 10, below, shows samples 15-17. Samples 15-16 were prepared by dry mix method, sample 17 was used as received.

TABLE 10

| Sample | 15 | 16 | 17 |
|---|---|---|---|
| Phenolic 1 (g) | 50 | 50 | |
| Phenolic 2 (g) | | | 100 |
| Saw dust (g) | 50 | — | — |
| Coal (g) | — | 50 | — |
| Compressive strength | 198 ± 9 | 69 ± 16 | 197 ± 4 |
| (MPa) | | | |
| Compressive elastic | 3.2 ± 0.3 | 2.7 ± 0.2 | 3.7 ± 0.1 |
| modulus (GPa) | | | |
| Tensile strength (MPa) | 63 ± 3 | — | 53 ± 2 |
| Volatile matter (TGA, %) | 61.4 | 45.5 | 54.3 |
| Fixed carbon (TGA, %) | 37.7 | 50.5 | 39.3 |
| Ash (TGA, %) | 0.8 | 4.0 | 6.4 |
| Ignition (TGA, ° C.) | 472 | 437 | 423 |
| Water absorption (2 h, | 0.2 | — | 0.2 |
| %) | | | |
| Water absorption (24 h, | 0.5 | — | 0.8 |
| %) | | | |

Samples 18-24, shown in Table 11 below, were prepared by dry mix method from 50 g Phenolic 1 and 50 g Coal char 1. For sample 18, coal char was wet-milled as aqueous dispersion in a bead mill. Its particle size was estimated using a grindometer with a 0-100 μm rage. Only three specimens were tested. The coal char for samples 19-24 was prepared by dry ball milling and sieving

TABLE 11

| Sample | 18 | 19 | 20 | 21 | 22 | 23 | 24 |
|---|---|---|---|---|---|---|---|
| Particle size | <1 | <25 | 25- | 50- | 75- | 100- | 150- |
| (μm) | | | 50 | 75 | 100 | 150 | 200 |
| Compressive | 175 ± | 244 ± | 255 ± | 242 ± | 250 ± | 260 ± | 214 ± |
| strength (MPa) | 31 | 10 | 7 | 18 | 8 | 7 | 23 |
| Compressive | 4.5 ± | 4.9 ± | 5.4 ± | 5.0 ± | 5.2 ± | 5.1 ± | 4.3 ± |
| elastic modulus | 0.1 | 0.2 | 0.2 | 0.3 | 0.5 | 0.5 | 0.3 |
| (GPa) | | | | | | | |

Samples 25-27, shown in Table 12 below, were prepared by dry mix method.

TABLE 12

| Sample | 25 | 26 | 27 |
|---|---|---|---|
| Phenolic 3 (g) | 50 | 67 | 70 |
| Coal char 1 (g) | 50 | 33 | 30 |
| Compressive strength | 135 ± 4 | 155 ± 5 | 24 ± 7 |
| (MPa) | | | |
| Compressive elastic | 4.1 ± 0.2 | 5.0 ± 0.2 | 1.6 ± 0.1 |
| modulus (GPa) | | | |

Samples 28-30, shown in Table 13 below, were prepared by dry mix method.

TABLE 13

| Sample | 28 | 29 | 30 |
|---|---|---|---|
| Phenolic 1 (g) | 40 | 50 | 60 |
| Coal char 2 (g) | 60 | — | — |
| Coal char 3 (g) | — | 50 | 40 |
| Specimen tested | 4 | 3 | 3 |
| Compressive strength | 73 ± 47 | 90 ± 39 | 55 ± 26 |
| (MPa) | | | |
| Compressive elastic | 2.8 ± 0.9 | 2.9 ± 0.6 | 2.6 ± 1.1 |
| modulus (GPa) | | | |
| Compressive strength | 142 | 130 | 71 |
| of strongest specimen | | | |
| (MPa) | | | |

### References Corresponding to Example 3

Ackerman2020: US20200332197 A1 (Published UW coal refinery patent application).
Benk2008: Benk, A., Talu, M., & Coban, A. (2008). Phenolic resin binder for the production of metallurgical quality briquesttes from coke breeze. https://doi.org/10.1016/j.fuproc.2007.06.005.
Dodiuk2013: Dodiuk, H., & Goodman, S. H. (2013). Handbook of thermoset plastics. Elsevier.
Fink 2005: Fink, J. K. (2005). Reactive polymers fundamentals and applications. William Andrew.
Goodman 1998: Goodman, S. H. (Ed.). (1998). Handbook of thermoset plastics, 2. ed., Noyes publications
Pilato2010: Pilato, L. (Ed.). (2010). Phenolic resins: A century of progress. Springer.
Tan2021: US 2021/0061714 A1 (Published UW char brick application).
Thethwayo2020: Thethwayo, B. M., & Steenkamp, J. D. (2020). A review of carbon-based refractory materials and their applications. Journal of the Southern African Institute of Mining and Metallurgy, Vol. 120, n. 11 (http://www.scielo.org.za/scielo.php?script=sci_arttext&pid=S2225-62532020001100008).
Wypych2016: Wypych, G. (2016). Handbook of polymers, 2. ed. ChemTec Publishing.

### Example 4

### Materials and Methods as Described for Example 3

Coal 2: Same coal as coal in example 3, but size fraction 63-149 μm.

Coal char 4: The coal char was prepared by heating a flow of coal particles (250-425 μm) in an inert gas stream to 1000° C. The time the particles are hot is less than 2 s. The char was ground and sieved to a particle size of 63-149 μm. TGA standard analysis showed 9% volatile matter, 77% fixed carbon and 13% ash.

Samples 31-33 show the low performance of coal as compared to coal char. Samples 34-36 show that coal char 4, prepared by economic flash pyrolysis in less than 2 s, still provides reasonable strength as filler

Samples 31-36, shown in Table 14 below, were prepared by solvent method using tetrahydrofuran (THF) as solvent.

TABLE 14

| Sample | 31 | 32 | 33 | 34 | 35 | 36 |
|---|---|---|---|---|---|---|
| Coal 2 (g) | 50 | 60 | 70 | — | — | — |
| Coal char 4 (g) | — | — | — | 50 | 60 | 70 |
| Phenolic 1 (g) | 50 | 40 | 30 | 50 | 40 | 30 |
| Specimen | 5 | 5 | 5 | 3 | 3 | 4 |
| tested | | | | | | |
| Compressive | 112 ± | 77 ± | 130 ± | 210 ± | 259 ± | 273 ± |
| strength (MPa_{—} | 51 | 56 | 28 | 105 | 31 | 52 |
| Compressive | 2.8 ± | 2.3 ± | 3.2 ± | 4.2 ± | 5.4 ± | 5.6 ± |
| modulus (GPa) | 0.7 | 1.2 | 0.4 | 1.3 | 0.3 | 0.6 |

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary aspects and optional features, modification and variation of the concepts herein disclosed may be resorted to by those skilled in the art, and that such modifications and variations are considered to be within the scope of this invention as defined by the appended claims. The specific aspects provided herein are examples of useful aspects of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some aspects is interchangeable with the expression “as in any one of claims XX-YY.”

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

Certain molecules disclosed herein may contain one or more ionizable groups [groups from which a proton can be removed (e.g., —COOH) or added (e.g., amines) or which can be quaternized (e.g., amines)]. All possible ionic forms of such molecules and salts thereof are intended to be included individually in the disclosure herein. With regard to salts of the compounds herein, one of ordinary skill in the art can select from among a wide variety of available counterions those that are appropriate for preparation of salts of this invention for a given application. In specific applications, the selection of a given anion or cation for preparation of a salt may result in increased or decreased solubility of that salt.

Every device, system, formulation, combination of components, or method described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific aspects that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred aspects and optional features, modification and variation of the concepts herein disclosed may be resorted to by those skilled in the art, and that such modifications and variations are considered to be within the scope of this invention as defined by the appended claims.

1. A method for producing a polymer composite material via a coal-derived feedstock, the method comprising:
pyrolyzing a coal-derived feedstock to produce coal char particles;
mixing the coal char particles with a polymer precursor to produce a composite precursor;
curing the composite precursor to produce a polymer composite material, wherein the curing comprises polymerizing the polymer precursor of the composite precursor to form a three-dimensionally chemically cross-linked network.

2. The method of claim 1 wherein the curing comprises:
heating the composite precursor; and
compressing the composite precursor.

3. The method of claim 1, wherein the composite precursor is a powder mixture.

4. The method of claim 1, wherein the curing of the composite precursor occurs at a temperature between 8° and 250° C.

5-6. (canceled)

7. The method of claim 1, wherein the mixing step comprises contacting the coal char particles with a polymer precursor solution, the polymer precursor solution comprising at least some of the polymer precursor and a solvent.

8-10. (canceled)

11. The method of claim 7, wherein the solvent is an organic solvent.

12. The method of claim 7, wherein the solvent is an aprotic solvent.

13. The method of claim 7, wherein the solvent is a polar solvent.

14. The method of claim 7, wherein the solvent is a polar, aprotic solvent that is not a ketone or aldehyde.

15. The method of claim 7, wherein the solvent is tetrahydrofuran.

16. The method of claim 7, wherein the coal char particles have a cross-sectional dimension less than or equal to 200 μm.

17. (canceled)

18. The method of claim 1, wherein the concentration of coal char particles in the polymer composite material is 40-90 wt. %.

19. (canceled)

20. The method of claim 1, wherein the pyrolyzing step comprises heating in the absence of oxygen to a temperature of 500-2000° C.

21-26. (canceled)

27. The method of claim 1, wherein the pyrolyzing step has a duration of 30 seconds or less.

28. The method of claim 1, wherein the composite precursor comprises non-coal char particles.

29. The method of claim 28, wherein the non-coal char particles include wood particles.

30. The method of claim 1, wherein the composite precursor comprises coal char particles and non-coal char particles, wherein the non-coal char particles are not molten or dissolved during the curing process, and wherein the concentration of coal char particles in the polymer composite material is at least 25 wt. % and the concentration of coal char particles and the non-coal char particles together in the polymer composite is at least 50 wt. %.

31. (canceled)

32. The method of claim 1, wherein the polymer precursor comprises a phenolic resin precursor.

33. The method of claim 1, wherein the polymer precursor comprises a phenolic novolac resin precursor.

34. The method of claim 1, wherein the polymer precursor comprises a phenolic resole resin precursor.

35. The method of claim 1, wherein the polymer precursor comprises a melamine resin precursor.

36. The method of claim 1, wherein the polymer precursor comprises a urea resin precursor.

37. The method of claim 1, wherein the polymer precursor comprises at least 60 wt. % of any of the resins from the group of phenol-formaldehyde resin, melamine-formaldehyde resin or urea-formaldehyde resin.

38. The method of claim 1, wherein the polymer precursor comprises at least 50 wt. % phenol-formaldehyde resin.

39. A building material produced via the method of claim 1, wherein the building material has compressive strength of at least 100 MPa and a tensile strength of at least 5 MPa.

40-42. (canceled)

43. The method of claim 1, wherein the composite precursor is a dry powder and wherein curing the composite precursor to produce the polymer composite material comprises curing the dry powder.

44. The method of claim 1, wherein the composite precursor is a wet powder.

45. The method of claim 1, wherein the polymer precursor comprises at least 60 wt. % of any of the resins from the group of phenol-formaldehyde resin, melamine-formaldehyde resin or urea-formaldehyde resin;
wherein mixing the coal char particles with the polymer precursor comprises contacting the coal char particles with a solution of phenol-formaldehyde resin, melamine-formaldehyde resin or urea-formaldehyde resin; and
wherein the composite precursor is cured as a dry or wet powder.

46. A building material produced via the method of claim 37, wherein the building material has compressive strength of at least 100 MPa and a tensile strength of at least 5 MPa.
